(19) United States
(12) Patent Application Publication
(10) Pub. No.: US 2024/0243872 A1
(43) Pub. Date: Jul. 18, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/423,307

(22) Filed: Jan. 26, 2024

Related U.S. Application Data
(63) Continuation of application No. PCT/CN2022/108194, filed on Jul. 27, 2022.

(30) Foreign Application Priority Data
Jul. 30, 2021 (CN) 202110869131.3

(51) Int. Cl. H04L 5/00; H04W 76/20; H04W 80/02

(52) U.S. Cl. CPC H04L 5/0051; H04W 76/20; H04W 80/02

(57) ABSTRACT

A communication node receives a first signaling, the first signaling used for configuring a first RS resource group, with all RS resources in the first RS resource group being associated with a first PCI; and receives a second signaling, the second signaling used for determining a first target RS resource group, which belongs to the first RS resource group; and performs a first action set as a response to the action of receiving the second signaling, the first action set including resetting a count of first-type indication(s); the first RS resource group comprises at least one RS resource; the first signaling is an RRC layer signaling; the second signaling is a signaling at protocol layer below the RRC layer; the first target RS resource group is used for radio link monitoring; the first-type indication is related to a link failure.

### CROSS REFERENCE TO RELATED APPLICATIONS

This application is the continuation of the international patent application No. PCT/CN2022/108194, filed on Jul. 27, 2022, and claims the priority benefit of Chinese Patent Application No. 202110869131.3, filed on Jul. 30, 2021, the full disclosure of which is incorporated herein by reference.

### BACKGROUND

### Technical Field

The present application relates to transmission methods and devices in wireless communication systems, and in particular to a transmission method and device for mobility.

### Related Art

The traditional Network Controlled mobility comprises cell-level mobility and beam-level mobility, where the cell-level mobility is dependent on Radio Resource Control (RRC) signaling and the beam-level mobility is not joined by RRC signaling Before the 3rd Generation Partnership Project (3GPP) R16, the beam-level mobility is only for Beam Management within a single cell. It was decided at the 3GPPRAN #80 conference that a Work Item (WI) of “Further enhancements on MIMO for NR” will be conducted to support multi-beam operation, for enhancements on L1/L2-centric inter-cell mobility and inter-cell mTRP, where L1 refers to Layer 1, and L2 refers to Layer 2, and mTRP refers to multiple Transmit/Receive Point.

### SUMMARY

To realize inter-cell L1/L2 mobility or inter-cell mTRP, when a UE (i.e., User Equipment) is in its serving cell, the network configures the UE with radio parameters of another cell by means of RRC messages, and the UE can use the TRP of another cell for data transmission within the coverage area of the serving cell. The other cell and the serving cell have different Physical Cell Identifiers (PCIs). When the UE uses another cell's TRP for data transmission within the serving cell, the employment of the current Radio Link Monitoring (RLM) mechanism can lead to untimely triggering of Radio Link Failure (RLF), which will affect the UE performance. Therefore, enhancement shall be made on the mechanism of radio link monitoring.

To address the above problem, the present application provides a solution. The description above only took uu-interface scenarios for example, though; the present application is also applicable to scenarios like sidelink ones, where similar technical effects can be achieved. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first signaling, the first signaling used for configuring a first Reference Signal (RS) resource group, with all RS resources in the first RS resource group being associated with a first Physical Cell Identity (PCI); receiving a second signaling, the second signaling used for determining a first target RS resource group, any RS resource in the first target RS resource group belonging to the first RS resource group; and performing a first action set as a response to the action of receiving the second signaling, the first action set including resetting a count of first-type indication(s);
herein, the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, a problem to be solved in the present application includes: how to avoid triggering of an RLF in a serving cell when a UE uses radio resources of a cell identified by another PCI in the serving cell.

In one embodiment, a problem to be solved in the present application includes: how to avoid triggering of an RLF too early when a UE uses radio resources of a cell identified by another PCI in the serving cell.

In one embodiment, a problem to be solved in the present application includes: how to perform RLM measurement when a UE configures radio resources of a cell identified by another PCI in the serving cell.

In one embodiment, characteristics of the above method include: a reference signal used for RLM is not only related to a serving cell, but also to a cell identified by another PCI.

In one embodiment, characteristics of the above method include: the second signaling is used to determine RS resources configured for the cell identified by the first PCI.

In one embodiment, characteristics of the above method include: when the first node uses a cell identified by the first PCI, the first node performs radio link monitoring according to the first target RS resource group.

In one embodiment, an advantage of the above method includes: avoiding triggering an RLF too quickly.

In one embodiment, an advantage of the above method includes: ensuring the UE's transmission quality.

In one embodiment, an advantage of the above method includes: enhancing the UE's service continuity.

According to one aspect of the present application, characterized in comprising:
receiving a third signaling, the third signaling used for configuring a second RS resource group, with all RS resources in the second RS resource group being associated with a second PCI;
herein, the first action set includes: performing radio link monitoring only according to a second target RS resource group in the second RS resource group; any RS resource in the second target RS resource group belongs to the second RS resource group; the second target RS resource group is used for radio link monitoring; the first PCI is different from the second PCI.

In one embodiment, characteristics of the above method include: when the first node uses a cell identified by the first PCI, the first node performs radio link monitoring according to the first target RS resource group and the second target RS resource group.

In one embodiment, characteristics of the above method include: before the first node uses a cell identified by the first PCI, the first node performs radio link monitoring according to the second target RS resource group.

In one embodiment, characteristics of the above method include: the second target RS resource group has been constantly used for performing radio link monitoring.

According to one aspect of the present application, characterized in comprising:
each time when a radio link quality evaluated is worse than a first threshold, a physical layer of the first node reports a first indication to a higher layer of the first node; the first-type indication includes the first indication; the first threshold is configurable.

According to one aspect of the present application, characterized in comprising:
each time when a radio link quality evaluated is better than a second threshold, a physical layer of the first node reports a second indication to a higher layer of the first node; the first-type indication includes the second indication; the second threshold is configurable.

According to one aspect of the present application, characterized in that the first action set includes stopping a first-type timer, the first-type timer being related to a link failure.

According to one aspect of the present application, characterized in comprising:
determining an occurrence of physical-layer problem; and starting a first timer as a response to the action of determining the occurrence of physical-layer problems;
herein, the first timer is maintained in the RRC layer; the first-type timer includes the first timer.

According to one aspect of the present application, characterized in comprising:
delivering a first Radio Link Control (RLC) Protocol Data Unit (PDU), the first RLC PDU including a polling indication; starting a third timer, along with the action of delivering the first RLC PDU;
herein, expiration of the third timer is used to determine a retransmission of a polling indication; the first-type timer includes the third timer.

According to one aspect of the present application, characterized in comprising:
determining to retransmit a first RLC Service Data Unit (SDU); and updating a count of third indication(s) as a response to the action of determining to retransmit the first RLC SDU;
herein, the count of the third indication(s) is used to determine a number of times the first RLC SDU has been retransmitted; the first-type indication includes the third indication.

According to one aspect of the present application, characterized in that an RS resource for radio link monitoring is related to all RS resources in a target observation set, and the RS resource for radio link monitoring is unrelated to any RS resource other than the target observation set; the target observation set consists of at least one of the first target RS resource group or the second target RS resource group.

The present application provides a method in a second node for wireless communications, comprising:
transmitting a first signaling, the first signaling used for configuring a first RS resource group, with all RS resources in the first RS resource group being associated with a first PCI; transmitting a second signaling, the second signaling used for determining a first target RS resource group, any RS resource in the first target RS resource group belonging to the first RS resource group;
herein, as a response to the second signaling being received, a first action set is performed, the first action set including resetting a count of first-type indication(s); the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

According to one aspect of the present application, characterized in comprising:
transmitting a third signaling, the third signaling used for configuring a second RS resource group, with all RS resources in the second RS resource group being associated with a second PCI;
herein, the first action set includes: performing radio link monitoring only according to a second target RS resource group in the second RS resource group; any RS resource in the second target RS resource group belongs to the second RS resource group; the second target RS resource group is used for radio link monitoring; the first PCI is different from the second PCI.

According to one aspect of the present application, characterized in that each time when a radio link quality evaluated is worse than a first threshold, a physical layer of a receiver of the first signaling reports a first indication to higher layers of the receiver of the first signaling; the first-type indication includes the first indication; the first threshold is configurable.

According to one aspect of the present application, characterized in that each time when a radio link quality evaluated is better than a second threshold, a physical layer of a receiver of the first signaling reports a second indication to higher layers of the receiver of the first signaling; the first-type indication includes the second indication; the second threshold is configurable.

According to one aspect of the present application, characterized in that the first action set includes stopping a first-type timer, the first-type timer being related to a link failure.

According to one aspect of the present application, characterized in that it is determined that physical-layer problems have occurred in a receiver of the first signaling; as a response to that it is determined that the physical-layer problems have occurred in the receiver of the first signaling, a first timer is started; herein, the first timer is maintained in the RRC layer; the first-type timer includes the first timer.

According to one aspect of the present application, characterized in that a first RLC PDU is delivered, the first RLC PDU including a polling indication; a third timer is started along with the action of delivering a first RLC PDU; herein, expiration of the third timer is used to determine a retransmission of a polling indication; the first-type timer includes the third timer.

According to one aspect of the present application, characterized in that a first RLC SDU is determined to be retransmitted; as a response to the first RLC SDU being determined to be retransmitted, a count of third indication(s) is updated; herein, the count of the third indication(s) is used to determine a number of times the first RLC SDU has been retransmitted; the first-type indication includes the third indication.

According to one aspect of the present application, characterized in that an RS resource for radio link monitoring is related to all RS resources in a target observation set, and the RS resource for radio link monitoring is unrelated to any RS resource other than the target observation set; the target observation set consists of at least one of the first target RS resource group or the second target RS resource group.

The present application provides a first node for wireless communications, comprising:
a first receiver, which receives a first signaling, the first signaling used for configuring a first Reference Signal (RS) resource group, with all RS resources in the first RS resource group being associated with a first Physical Cell Identity (PCI); and which receives a second signaling, the second signaling used for determining a first target RS resource group, any RS resource in the first target RS resource group belonging to the first RS resource group; and which performs a first action set as a response to the action of receiving the second signaling, the first action set including resetting a count of first-type indication(s);
herein, the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

The present application provides a second node for wireless communications, comprising:
a second transmitter, which transmits a first signaling, the first signaling used for configuring a first Reference Signal (RS) resource group, with all RS resources in the first RS resource group being associated with a first Physical Cell Identity (PCI); and which transmits a second signaling, the second signaling used for determining a first target RS resource group, any RS resource in the first target RS resource group belonging to the first RS resource group;
herein, as a response to the second signaling being received, a first action set is performed, the first action set including resetting a count of first-type indication(s); the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, compared with the prior art, the present application is advantageous in the following aspects:
avoiding triggering an RLF too quickly;
ensuring the UE's transmission quality;
enhancing the UE's service continuity.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmitting a first signaling and a second signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of radio signal transmission according to a third embodiment of the present application.

FIG. 8 illustrates a schematic diagram of a physical layer of a first node reporting a first indication to a higher layer of the first node according to one embodiment of the present application.

FIG. 9 illustrates a schematic diagram of a physical layer of a first node reporting a second indication to a higher layer of the first node according to one embodiment of the present application.

FIG. 10 illustrates a schematic diagram illustrating a relation between a second node and a third node according to one embodiment of the present application.

FIG. 11 illustrates a schematic diagram of a first notification according to one embodiment of the present application.

FIG. 12 illustrates a structure block diagram of a processing device used in a first node according to one embodiment of the present application.

FIG. 13 illustrates a structure block diagram of a processing device used in a second node according to one embodiment of the present application.

FIG. 14 illustrates a schematic diagram of a target observation set consisting of at least one of a first target RS resource group or a second target RS resource group according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

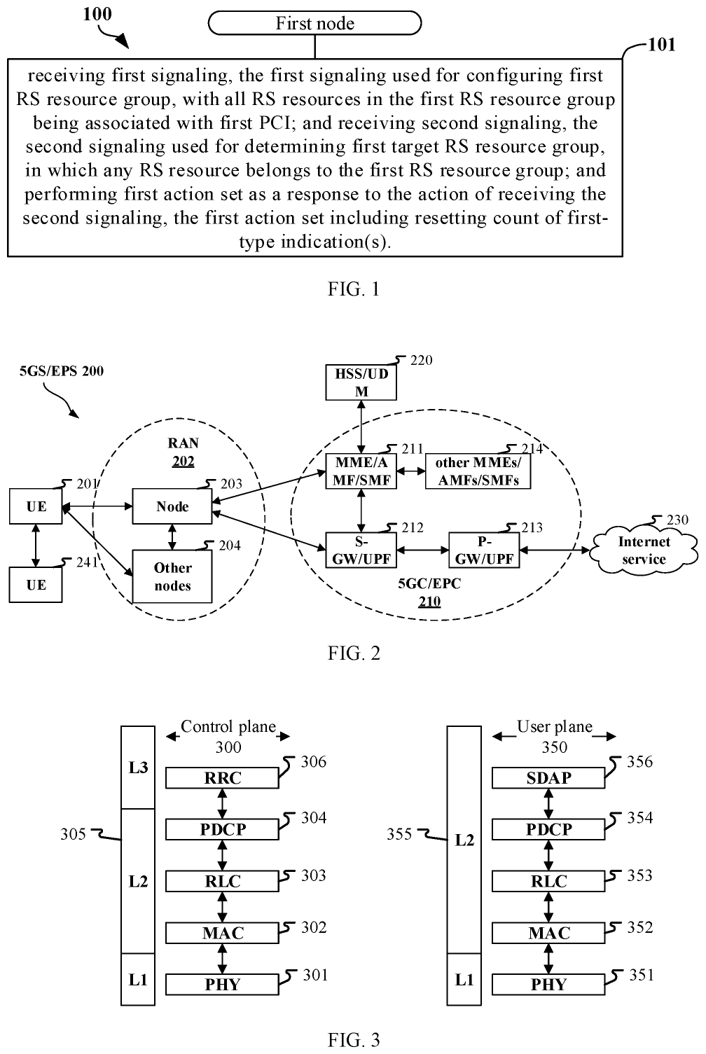

Embodiment 1 illustrates a flowchart of transmitting a first signaling and a second signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101, the first signaling used for configuring a first Reference Signal (RS) resource group, with all RS resources in the first RS resource group being associated with a first Physical Cell Identity (PCI); and receives a second signaling, the second signaling used for determining a first target RS resource group, any RS resource in the first target RS resource group belonging to the first RS resource group; and performs a first action set as a response to the action of receiving the second signaling, the first action set including resetting a count of first-type indication(s); herein, the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, the first RS resource group belongs to the cell identified by the first PCI, while the second RS resource group belongs to the cell identified by the second PCI.

In one embodiment, the first target RS resource group is determined from the first RS resource group; the second target RS resource group is determined from the second RS resource group.

In one embodiment, all RS resources in the first target RS resource group are associated with a Transmission Configuration Indicator (TCI) state for Physical downlink control channel (PDCCH) reception.

In one embodiment, all RS resources in the first target RS resource group are associated with an activated TCI state for PDCCH reception.

In one embodiment, the first target RS resource group comprises at least one RS resource.

In one embodiment, the first target RS resource group comprises only one RS resource.

In one embodiment, any RS resource in the first RS resource group is different from any RS resource in the second RS resource group.

In one embodiment, there is one RS resource in the first RS resource group being identical to an RS resource in the second RS resource group.

In one embodiment, the first signaling is transmitted via a Uu interface.

In one embodiment, the first signaling is transmitted via a PC5 interface.

In one embodiment, the first signaling comprises a RRCReconfiguration message.

In one embodiment, the first signaling comprises a System Information Block 1 (SIB1) message.

In one embodiment, the first signaling comprises a SystemInformation message.

In one embodiment, a logical channel of the first signaling includes a Broadcast Control Channel (BCCH).

In one embodiment, a logical channel of the first signaling includes a Dedicated Control Channel (DCCH).

In one embodiment, a logical channel of the first signaling includes a Common Control Channel (CCCH).

In one embodiment, a logical channel of the first signaling includes a Sidelink Control Channel (SCCH).

In one embodiment, a logical channel of the first signaling includes a Sidelink Broadcast Control Channel (SBCCH).

In one embodiment, the first signaling comprises a Downlink (DL) signaling.

In one embodiment, the first signaling comprises a Sidelink (SL) signaling.

In one embodiment, the first signaling is an RRC message.

In one embodiment, the first signaling comprises at least one RRC message.

In one embodiment, the first signaling comprises at least one Information Element (IE) in an RRC message.

In one embodiment, the first signaling comprises at least one Field in an RRC message.

In one embodiment, the first signaling is a field or an IE other than an IE RadioLinkMonitoringConfig.

In one embodiment, the first signaling comprises at least one IE other than an IE RadioLinkMonitoringConfig.

In one embodiment, at least one IE or at least one field in the first signaling other than an IE RadioLinkMonitoringConfig indicates the first RS resource group.

In one subembodiment, the first signaling comprises a ControlResourceSet IE, with at least one field in the ControlResourceSet IE indicating the first RS resource group.

In one subembodiment, the first signaling comprises a TCI-State IE, with at least one field in the TCI-State IE indicating the first RS resource group.

In one subembodiment, the first signaling comprises at least one referenceSignal field, the at least one referenceSignal field indicating the first RS resource group.

In one embodiment, an IE RadioLinkMonitoringConfig in the first signaling is used for indicating the first RS resource group.

In one embodiment, the first signaling comprises M sub-signaling(s), of which each sub-signaling comprises an IE RadioLinkMonitoringConfig, M being a number of BWP(s).

In one embodiment, the first signaling comprises at least an IE RadioLinkMonitoringConfig.

In one embodiment, the first signaling comprises at least a failureDetectionResourcesToAddModList field.

In one embodiment, the first signaling is a failureDetectionResourcesToAddModList field.

In one embodiment, a RadioLinkMonitoringRS field in the first signaling is used for configuring an RS in the first RS resource group.

In one embodiment, a detectionResource field in the first signaling is used for configuring an index of any RS resource of the at least one RS resource in the first RS resource group.

In one embodiment, a detectionResource field in the first signaling is used for configuring a type of any RS resource of the at least one RS resource in the first RS resource group.

In one embodiment, a detectionResource field in the first signaling is used for configuring a type and an index of any RS resource of the at least one RS resource in the first RS resource group.

In one embodiment, the first signaling is used for configuring a set of resource indexes, the set of resource indexes being used to determine the first RS resource group.

In one embodiment, a csi-RS-Index in the first signaling is used to determine a CSI-RS resource configuration index, or a ssb-Index in the first signaling is used to determine a SS/PBCH block index.

In one embodiment, the phrase of the first signaling used for configuring a first RS resource group comprises that: the first signaling is used to determine any RS resource in the first RS resource group.

In one embodiment, the phrase of the first signaling used for configuring a first RS resource group comprises that: the first signaling is used to determine an index of each RS resource in the first RS resource group.

In one embodiment, the phrase of the first signaling used for configuring a first RS resource group comprises that: the first signaling is used to determine a type of each RS resource in the first RS resource group.

In one embodiment, the phrase of the first signaling used for configuring a first RS resource group comprises that: the first signaling is used to determine an index and a type of each RS resource in the first RS resource group.

In one embodiment, the phrase of all RS resources in the first RS resource group being associated with a first PCI comprises that: the first PCI is used for generating a reference signal corresponding to all RS resources in the first RS resource group.

In one embodiment, the phrase of all RS resources in the first RS resource group being associated with a first PCI comprises that: all RS resources in the first RS resource group are Quasi co-located (QCL) with the cell identified by the first PCI.

In one embodiment, the phrase of all RS resources in the first RS resource group being associated with a first PCI comprises that: the reference signal in the cell identified by the first PCI is transmitted using an RS resource in the first RS resource group.

In one embodiment, the phrase of all RS resources in the first RS resource group being associated with a first PCI comprises that: all RS resources in the first RS resource group are for the first PCI configuration.

In one embodiment, the phrase of all RS resources in the first RS resource group being associated with a first PCI comprises that: all RS resources in the first RS resource group belonging to the cell identified by the first PCI.

In one embodiment, the phrase of all RS resources in the first RS resource group being associated with a first PCI comprises that: the cell identified by the first PCI transmits a reference signal on RS resources in the first RS resource group.

In one embodiment, the phrase of all RS resources in the first RS resource group being associated with a first PCI comprises that: at least one RS resource in the first RS resource group is used for the cell identified by the first PCI transmitting a reference signal.

In one embodiment, the second signaling comprises a MAC Control Element (CE).

In one embodiment, the second signaling comprises a MAC subheader.

In one embodiment, the second signaling comprises a MAC PDU.

In one embodiment, the second signaling comprises a piece of Downlink Control Information (DCI).

In one embodiment, the second signaling is UE-specific.

In one embodiment, the second signaling indicates a UE-specific PDCCH TCI state.

In one embodiment, the second signaling indicates a UE-specific Physical downlink shared channel (PDSCH) TCI state.

In one embodiment, the phrase of the second signaling used for determining a first target RS resource group comprises that: the second signaling is used to determine an activation of the first target RS resource group.

In one embodiment, the phrase of the second signaling used for determining a first target RS resource group comprises that: the second signaling is used to determine that the first target RS resource group is used for RLM.

In one embodiment, the phrase of the second signaling used for determining a first target RS resource group comprises that: the second signaling is used to determine the first RS resource group, any RS resource in the first target RS resource group belonging to the first RS resource group.

In one embodiment, the phrase of the second signaling used for determining a first target RS resource group comprises that: the second signaling explicitly indicates an RS resource identifier in the first target RS resource group.

In one embodiment, the phrase of the second signaling used for determining a first target RS resource group comprises that: the second signaling implicitly indicates an RS resource identifier in the first target RS resource group.

In one embodiment, the phrase of the second signaling used for determining a first target RS resource group comprises that: the second signaling implicitly indicates an RS resource identifier in the first target RS resource group.

In one embodiment, the second signaling indicates a target TCI, the target TCI being associated with the cell identified by the first PCI.

In one embodiment, the second signaling indicates that a target Control Resource Set (CORESET) is used to determine that all RS resources in the first RS resource group are associated with the first PCI; where the target CORESET is associated with the cell identified by the first PCI.

In one embodiment, the phrase of any RS resource in the first target RS resource group belonging to the first RS resource group comprises that: all RS resources in the first target RS resource group are all or part of all RS resources in the first RS resource group.

In one embodiment, the phrase of any RS resource in the first target RS resource group belonging to the first RS resource group comprises that: any RS resource in the first target RS resource group is identical to an RS resource in the first RS resource group.

In one embodiment, the phrase of any RS resource in the first target RS resource group belonging to the first RS resource group comprises that: the first target RS resource group is identical to the first RS resource group.

In one embodiment, the phrase of any RS resource in the first target RS resource group belonging to the first RS resource group comprises that: the first target RS resource group is a subset in the first RS resource group.

In one embodiment, as a response to the action of receiving a second signaling, the first target RS resource group is selected from the first RS resource group.

In one embodiment, as a response to the action of receiving a second signaling, the second target RS resource group is selected from the second RS resource group.

In one embodiment, as a response to the action of receiving a second signaling, the first target RS resource group is selected from the first RS resource group, and the second target RS resource group is selected from the second RS resource group.

In one embodiment, the first RS resource group is associated with a PDCCH.

In one embodiment, the first RS resource group is used for receiving a PDCCH.

In one embodiment, the first RS resource group belongs to an activated TCI for receiving PDCCH.

In one embodiment, the first RS resource group comprises Semi-Persistent (SP) CSI Reference Signal (CSI-RS) resources.

In one embodiment, the first RS resource group comprises SP CSI Interference Measurement (CSI-IM) resources.

In one embodiment, as a response to the action of receiving a second signaling, a count of first-type indication(s) is reset.

In one embodiment, the action of receiving a second signaling triggers the action of performing a first action set.

In one embodiment, the action of receiving a second signaling is used to determine performance of the action of performing a first action set.

In one embodiment, the phrase as a response to the action of receiving the second signaling includes: when the second signaling is received.

In one embodiment, the phrase as a response to the action of receiving the second signaling includes: if the second signaling is received.

In one embodiment, the phrase as a response to the action of receiving the second signaling includes: if a MAC entity has received the second signaling.

In one embodiment, the action of performing a first action set includes: performing all actions in the first action set.

In one embodiment, the action of performing a first action set includes: performing at least one action in the first action set.

In one embodiment, the action of performing a first action set includes: performing one action in the first action set.

In one embodiment, the action of performing a first action set includes: performing each action in the first action set.

In one embodiment, the phrase of the first action set including resetting a count of first-type indication(s) includes: the action of resetting the count of first-type indication(s) is at least one action in the first action set.

In one embodiment, the phrase of the first action set including resetting a count of first-type indication(s) includes: the first action set includes one action, the action being resetting the count of the first-type indication(s).

In one embodiment, the phrase of the first action set including resetting a count of first-type indication(s) includes: the first action set refers to resetting the count of the first-type indication(s).

In one embodiment, the phrase of the first action set including resetting a count of first-type indication(s) includes: the first action set refers to resetting the count of Q1 first-type indication(s), Q1 being a positive integer.

In one subembodiment, the Q1 first-type indication(s) includes/include at least one of a beam failure instance indication, or a LBT failure indication, or an “in-sync” indication, or an “out-of-sync” indication, or either an RLC SDU or an RLC SDU segment being deemed to be retransmitted.

In one subembodiment, Q1 is equal to 1.

In one subembodiment, Q1 is greater than 1.

In one subembodiment, Q1 is no greater than 64.

In one embodiment, the action of resetting the count of first-type indication(s) includes: resetting the count of all the first-type indication(s).

In one embodiment, the action of resetting the count of first-type indication(s) includes: resetting the count of at least one first-type indication.

In one embodiment, the action of resetting the count of first-type indication(s) includes: resetting the count of one first-type indication.

In one embodiment, the action of resetting the count of first-type indication(s) includes: clearing a counter used for counting the number of the first-type indication(s).

In one embodiment, the action of resetting the count of first-type indication(s) includes: clearing the count of the first-type indication(s).

In one embodiment, the action of resetting the count of first-type indication(s) includes: setting the count of the first-type indication(s) to 0.

In one embodiment, the action of resetting the count of first-type indication(s) includes: setting the count of the first-type indication(s) to an initial value.

In one embodiment, the action of resetting the count of first-type indication(s) includes: resetting a counter, the counter being used for counting the first-type indication(s).

In one embodiment, when the action of resetting the count of first-type indication(s) is performed, an RRC message for reconfiguring the first value is not received.

In one embodiment, when the action of resetting the count of first-type indication(s) is performed, an RRC message for reconfiguring a first RS resource group is not received.

In one embodiment, when the action of resetting the count of first-type indication(s) is performed, an RRC message for reconfiguring a beamFailureDetectionTimer is not received.

In one embodiment, the count of the first-type indication(s) refers to a number of the first-type indication(s).

In one embodiment, the count of the first-type indication(s) refers to a quantity of the first-type indication(s).

In one embodiment, a counter is used for the count of the first-type indication(s).

In one embodiment, a BFI_COUNTER is used for the count of the first-type indication(s).

In one embodiment, a N310 is used for the count of the first-type indication(s).

In one embodiment, a N311 is used for the count of the first-type indication(s).

In one embodiment, a RETX_COUNT is used for the count of the first-type indication(s).

In one embodiment, the first-type indication(s) is(are) transmitted via a cross-layer interface of the first node.

In one embodiment, the first-type indication(s) is(are) not transmitted via an air interface.

In one embodiment, the first-type indication(s) is(are) conveyed internally in the first node.

In one embodiment, the first-type indication(s) is(are) transmitted to a higher layer of the first node by a physical layer of the first node.

In one subembodiment, the higher layers include a MAC layer.

In one subembodiment, the higher layers include an RRC layer.

In one embodiment, the first-type indication includes: beam failure instance indication.

In one embodiment, the first-type indication includes: LBT failure indication.

In one embodiment, the first-type indication includes: “in-sync” indication.

In one embodiment, the first-type indication includes: “out-of-sync” indication.

In one embodiment, the first-type indication includes: an RLC Service Data Unit (SDU) or an RLC SDU segment being deemed to be retransmitted.

In one embodiment, the larger number of the first-type indication(s), the easier it is to trigger the link failure.

In one embodiment, the larger number of the first-type indication(s), the easier it is to avoid the link failure.

In one embodiment, the phrase that the first-type indication is related to a link failure includes: the number of the first-type indication(s) is related to the link failure.

In one embodiment, the phrase that the first-type indication is related to a link failure includes: the number of the first-type indication(s) is used to determine the link failure.

In one embodiment, the phrase that the first-type indication is related to a link failure includes: the number of the first-type indication(s) is used to trigger the link failure.

In one embodiment, the phrase that the first-type indication is related to a link failure includes: the number of the first-type indication(s) is used to avoid the link failure.

In one embodiment, the phrase that the first-type indication is related to a link failure includes: the number of the first-type indication(s) is used to trigger the link failure.

In one embodiment, the phrase that the first-type indication is related to a link failure includes: the number of the first-type indication(s) is used for link failure recovery.

In one embodiment, the link failure includes: being Radio Link Failure (RLF)-related.

In one embodiment, the link failure includes: being Beam Link Failure (BLF)-related.

In one embodiment, the link failure includes: being related to BLF of a TRP.

In one embodiment, the link failure includes: being related to BLF of a cell.

In one embodiment, the phrase that the first RS resource group comprises at least one RS resource comprises that: the first RS resource group comprises one RS resource.

In one embodiment, the phrase that the first RS resource group comprises at least one RS resource comprises that: the first RS resource group comprises more than one RS resource.

In one embodiment, the phrase that the first RS resource group comprises at least one RS resource comprises that: the first RS resource group comprises one or more than one RS resource.

In one embodiment, the phrase that the first RS resource group comprises at least one RS resource comprises that: a number of RS resource(s) in the first RS resource group is configurable.

In one embodiment, a type of an RS resource includes a Synchronization Signal/physical broadcast channel Block (SSB) resource.

In one embodiment, a type of an RS resource includes a CSI-RS resource.

In one embodiment, a type of an RS resource includes a CSI-IM resource.

In one embodiment, a type of an RS resource includes a Demodulation Reference Signal (DMRS) resource.

In one embodiment, a type of an RS resource includes a Sounding Reference Signal (SRS) resource.

In one embodiment, a type of an RS resource includes a Cell Reference Signal (CRS) resource.

In one embodiment, the phrase that the first signaling is a Radio Resource Control (RRC) layer signaling comprises that: the first signaling is generated by the RRC layer.

In one embodiment, the phrase that the first signaling is a Radio Resource Control (RRC) layer signaling comprises that: the first signaling is an RRC message.

In one embodiment, the phrase that the first signaling is a Radio Resource Control (RRC) layer signaling comprises that: the first signaling is transmitted by means of an RRC message.

In one embodiment, the phrase that the first signaling is a Radio Resource Control (RRC) layer signaling comprises that: the first signaling comprises an RRC Protocol Data Unit (PDU).

In one embodiment, the phrase that the second signaling is a signaling at protocol layer below the RRC layer comprises that: the second signaling is a MAC layer signaling.

In one embodiment, the phrase that the second signaling is a signaling at protocol layer below the RRC layer comprises that: the second signaling is a physical layer signaling.

In one embodiment, the phrase that the second signaling is a signaling at protocol layer below the RRC layer comprises that: the second signaling is not an RRC layer signaling.

In one embodiment, that an RS resource group is used for radio link monitoring means that: each RS resource in the RS resource group can be used for performing radio link monitoring; the RS resource group comprises the first target RS resource group or the second target RS resource group.

In one embodiment, that an RS resource group is used for radio link monitoring means that: all RS resources in the RS resource group are used for performing radio link monitoring; the RS resource group comprises the first target RS resource group or the second target RS resource group.

In one embodiment, that an RS resource group is used for radio link monitoring means that: partial RS resources in the RS resource group are used for performing radio link monitoring; the RS resource group comprises the first target RS resource group or the second target RS resource group.

In one embodiment, the radio link monitoring includes: Radio link monitoring (RLM).

In one embodiment, the radio link monitoring includes: monitoring downlink radio link quality of a primary cell (PCell) so as to indicate an in-sync status or an out-of-sync status for higher layers.

In one embodiment, the radio link monitoring includes: monitoring downlink radio link quality of a PSCell of an SCG (Primary SCG Cell) so as to indicate an in-sync status or an out-of-sync status for higher layers.

In one embodiment, the radio link monitoring includes: a Link recovery procedure.

In one embodiment, the radio link monitoring includes: monitoring downlink radio link quality of a serving cell, so as to indicate a beam failure instance for higher layers.

In one embodiment, the radio link monitoring includes: performing radio link monitoring according to a target observation set.

In one embodiment, as long as the first node keeps an RRC_CONNECTED state, radio link monitoring is performed.

In one embodiment, the first node performs radio link monitoring before the action of performing a first action set and after the action of performing the first action set.

In one embodiment, before a first time and after the first time, the second target RS resource group is constantly used for radio link monitoring.

In one subembodiment, the cell identified by the second PCI is the first cell; the cell identified by the first PCI is the second cell.

In one embodiment, at the same time, either of the first target RS resource group and the second target RS resource group is used for radio link monitoring.

In one subembodiment, the cell identified by the second PCI is the first cell; the cell identified by the first PCI is the second cell.

In one subembodiment, the cell identified by the second PCI is the second cell; the cell identified by the first PCI is the first cell.

In one subembodiment, radio link monitoring is performed only according to the first target RS resource group in the first RS resource group.

In one embodiment, as a response to the action of receiving a second signaling, radio link monitoring is performed only according to the first target RS resource group in the first RS resource group.

In one embodiment, the sentence of “performing radio link monitoring only according to the first target RS resource group in the first RS resource group” includes: performing radio link monitoring according to the first target RS resource group in the first RS resource group within an evaluation period.

In one embodiment, the sentence of “performing radio link monitoring only according to the first target RS resource group in the first RS resource group” includes: performing radio link monitoring according to a measurement of the first target RS resource group in the first RS resource group.

In one embodiment, the action of performing radio link monitoring only according to the first target RS resource group includes: the first target RS resource group in the first RS resource group is used for performing radio link monitoring.

In one embodiment, the sentence of “performing radio link monitoring only according to the first target RS resource group in the first RS resource group” includes: all RS resources in the first target RS resource group in the first RS resource group are used for radio link monitoring.

In one embodiment, the sentence of “performing radio link monitoring only according to the first target RS resource group in the first RS resource group” includes: part of RS resources in the first target RS resource group in the first RS resource group are used for radio link monitoring.

In one embodiment, the sentence of “performing radio link monitoring only according to the first target RS resource group in the first RS resource group” includes: performing radio link monitoring according to the N2 RS resources in the first target RS resource group.

In one embodiment, the sentence of “performing radio link monitoring only according to the first target RS resource group in the first RS resource group” includes: performing radio link monitoring according to a measurement of the N2 RS resources in the first target RS resource group.

In one embodiment, the sentence of “performing radio link monitoring only according to the first target RS resource group in the first RS resource group” includes: determining according to the first target RS resource group whether a beam failure or a cell level radio link failure is monitored.

In one embodiment, the sentence of “performing radio link monitoring only according to the first target RS resource group in the first RS resource group” includes: RS resources other than the first RS resource group are not used for performing radio link monitoring.

In one embodiment, the sentence of “performing radio link monitoring only according to the first target RS resource group in the first RS resource group” includes: RS resources other than the first target RS resource group in the first RS resource group are not used for performing radio link monitoring.

In one embodiment, the cell identified by the first PCI is a candidate cell for inter-cell L1/L2 mobility or inter-cell mTRP.

In one embodiment, the cell identified by the first PCI is a candidate cell among multiple candidate cells for inter-cell L1/L2 mobility or inter-cell mTRP.

In one embodiment, the second signaling indicates that the cell identified by the first PCI is used for inter-cell L1/L2 mobility or inter-cell mTRP.

In one subembodiment, the second signaling indicates explicitly.

In one subembodiment, the second signaling indicates implicitly.

In one subembodiment, the second signaling indicates two TCIs, and the two TCIs being respectively associated with the first cell and the second cell is used to indicate that the cell identified by the first PCI is used for inter-cell mTRP.

In one subembodiment, the second signaling indicates one TCI, and the TCI being associated with one cell is used to indicate that the cell identified by the first PCI is used for inter-cell L1/L2 mobility.

In one subembodiment, the inter-cell L1/L2 mobility includes at least one of a PDCCH or a PUSCH or a PDSCH being only associated with one of the first cell or the second cell simultaneously.

In one subembodiment, the inter-cell mTRP includes at least one of a PDCCH or a PUSCH or a PDSCH being associated with the first cell and the second cell simultaneously.

### Embodiment 2

Embodiment 2 illustrates a schematic diagram of a network architecture according to one embodiment of the present application, as shown in FIG. 2. FIG. 2 is a diagram illustrating a network architecture 200 of 5G New Radio (NR)/Long-Term Evolution (LTE)/Long-Term Evolution Advanced (LTE-A) system. The 5G NR/LTE/LTE-A network architecture 200 may be called 5G System/Evolved Packet System (5GS/EPS) 200 or other appropriate terms. The 5GS/EPS 200 may comprise one or more UEs 201, a RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and another node 204. The node 203 provides UE 201 oriented user plane and control plane terminations. The node 203 can be connected to another node 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point to the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to 5GC/EPC 210 via a S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the UE 201 is an ender.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 is a UE.

In one embodiment, the node 203 is a relay.

In one embodiment, the node 203 is a Gateway.

In one embodiment, the node 203 comprises at least one TRP.

In one embodiment, the node 204 corresponds to the third node in the present application.

In one embodiment, the node 204 corresponds to the fourth node in the present application.

In one embodiment, the node 204 is a BaseStation (BS).

In one embodiment, the node 204 is a BS.

In one embodiment, the node 204 is a BTS.

In one embodiment, the node 204 is a NB.

In one embodiment, the node 204 is a gNB.

In one embodiment, the node 204 is an eNB.

In one embodiment, the node 204 is a ng-eNB.

In one embodiment, the node 204 is an en-gNB.

In one embodiment, the node 204 is a UE.

In one embodiment, the node 204 is a relay.

In one embodiment, the node 204 is a Gateway.

In one embodiment, the node 204 comprises at least one TRP.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE comprises a piece of equipment supporting transmissions with low delay and high reliability.

In one embodiment, the UE comprises test equipment.

In one embodiment, the UE comprises a signaling test instrument.

In one embodiment, the UE supports NR.

In one embodiment, the UE supports UTRA.

In one embodiment, the UE supports EUTRA.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises abase station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling test instrument.

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

In one embodiment, at least one of a connection between the UE 201 and the node 203 or a connection between the UE 201 and the node 204 exists.

In one subembodiment, the connection between the UE 201 and the node 203 exists, while the connection between the UE 201 and the node 204 does not exist.

In one subembodiment, the connection between the UE 201 and the node 203 does not exist, while the connection between the UE 201 and the node 204 exists.

In one subembodiment, the connection between the UE 201 and the node 203 exists, and the connection between the UE 201 and the node 204 exists.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, which comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell, as well as for HARQ operation. In the control plane 300, The RRC sublayer 306 in the L3 layer is responsible for acquiring radio resources (i.e., radio bearer) and configuring the lower layer using an RRC signaling The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the radio protocol architecture in FIG. 3 is applicable to the third node in the present application.

In one embodiment, the radio protocol architecture in FIG. 3 is applicable to the fourth node in the present application.

In one embodiment, the first signaling in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the MAC 302 or the MAC 352.

In one embodiment, the second signaling in the present application is generated by the PHY 301 or the PHY 351.

In one embodiment, the first RLC PDU in the present application is generated by the RRC 306.

In one embodiment, the first RLC PDU in the present application is generated by the PDCP 304 or the PDCP 354.

In one embodiment, the first RLC PDU in the present application is generated by the RLC 303 or the RLC 353.

In one embodiment, the first RLC SDU in the present application is generated by the RRC 306.

In one embodiment, the first RLC SDU in the present application is generated by the PDCP 304 or the PDCP 354.

In one embodiment, the first RLC SDU in the present application is generated by the RLC 303 or the RLC 353.

### Embodiment 4

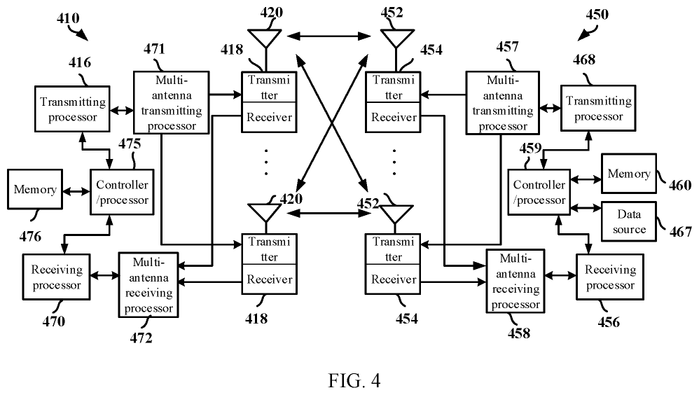

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication node 450 comprises at least one processor and at least one memory, the at least one memory comprises computer program codes; the at least one memory and the computer program codes are configured to be used in collaboration with the at least one processor, the first communication device 450 at least: receives a first signaling, the first signaling used for configuring a first RS resource group, with all RS resources in the first RS resource group being associated with a first PCI; and receives a second signaling, the second signaling used for determining a first target RS resource group, any RS resource in the first target RS resource group belonging to the first RS resource group; and performs a first action set as a response to the action of receiving the second signaling, the first action set including resetting a count of first-type indication(s); herein, the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, the first communication node 450 comprises a memory that stores a computer readable instruction program, the computer readable instruction program generates actions when executed by at least one processor, which include: receiving a first signaling, the first signaling used for configuring a first RS resource group, with all RS resources in the first RS resource group being associated with a first PCI; and receiving a second signaling, the second signaling used for determining a first target RS resource group, any RS resource in the first target RS resource group belonging to the first RS resource group; and performing a first action set as a response to the action of receiving the second signaling, the first action set including resetting a count of first-type indication(s); herein, the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, the second communication node 410 comprises at least one processor and at least one memory, the at least one memory comprises computer program codes; the at least one memory and the computer program codes are configured to be used in collaboration with the at least one processor. The second communication device 410 at least: transmits a first signaling, the first signaling used for configuring a first RS resource group, with all RS resources in the first RS resource group being associated with a first PCI; and transmits a second signaling, the second signaling used for determining a first target RS resource group, any RS resource in the first target RS resource group belonging to the first RS resource group; herein, as a response to the second signaling being received, a first action set is performed, the first action set including resetting a count of first-type indication(s); the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, the second communication node 410 comprises a memory that stores a computer readable instruction program, the computer readable instruction program generates actions when executed by at least one processor, which include: transmitting a first signaling, the first signaling used for configuring a first RS resource group, with all RS resources in the first RS resource group being associated with a first PCI; and transmitting a second signaling, the second signaling used for determining a first target RS resource group, any RS resource in the first target RS resource group belonging to the first RS resource group; herein, as a response to the second signaling being received, a first action set is performed, the first action set including resetting a count of first-type indication(s); the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, the antenna 452, the receiver 454, the receiving processor 456, and the controller/processor 459 are used for receiving a first signaling; at least one of the antenna 420, the transmitter 418, the transmitting processor 416 or the controller/processor 475 is used for transmitting a first signaling.

In one embodiment, the antenna 452, the receiver 454, the receiving processor 456, and the controller/processor 459 are used for receiving a second signaling; at least one of the antenna 420, the transmitter 418, the transmitting processor 416 or the controller/processor 475 is used for transmitting a second signaling.

In one embodiment, the antenna 452, the receiver 454, the receiving processor 456, and the controller/processor 459 are used for receiving a third signaling; at least one of the antenna 420, the transmitter 418, the transmitting processor 416 or the controller/processor 475 is used for transmitting a third signaling.

In one embodiment, the antenna 452, the transmitter 454, the transmitting processor 468 and the controller/processor 459 are used for transmitting a first RLC PDU; at least one of the antenna 420, the receiver 418, the receiving processor 470 or the controller/processor 475 is used for receiving a first RLC PDU.

In one embodiment, the antenna 452, the transmitter 454, the transmitting processor 468 and the controller/processor 459 are used for transmitting a first RLC SDU; at least one of the antenna 420, the receiver 418, the receiving processor 470 or the controller/processor 475 is used for receiving a first RLC SDU.

In one embodiment, the first communication device 450 corresponds to the first node in the present application.

In one embodiment, the second communication device 410 corresponds to the second node in the present application.

In one embodiment, the second communication device 410 corresponds to the third node in the present application.

In one embodiment, the second communication device 410 corresponds to the fourth node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

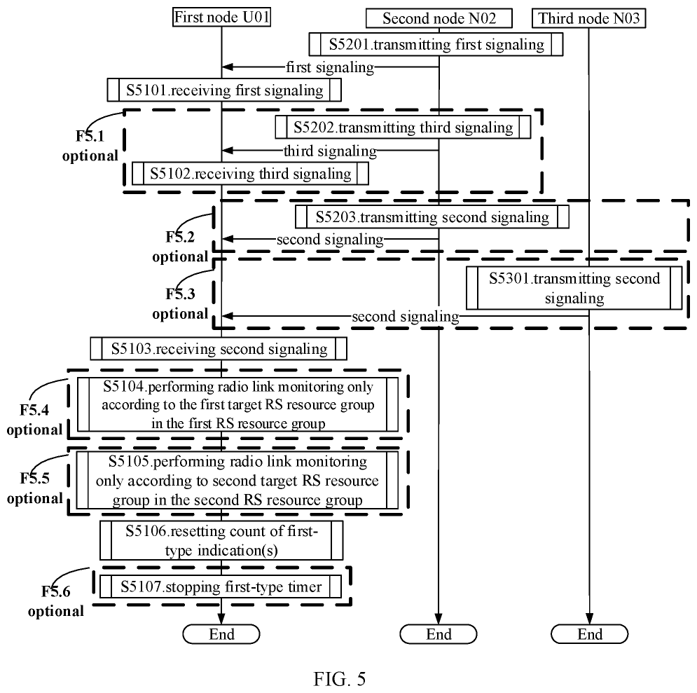

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first signaling in step S5101, the first signaling used for configuring a first Reference Signal (RS) resource group, with all RS resources in the first RS resource group being associated with a first Physical Cell Identity (PCI); and receives a third signaling in step S5102, the third signaling used for configuring a second RS resource group, with all RS resources in the second RS resource group being associated with a second PCI; and receives a second signaling in step S5103, the second signaling used for determining a first target RS resource group, any RS resource in the first target RS resource group belonging to the first RS resource group; and in step S5104, as a response to the action of receiving a second signaling, performs radio link monitoring only according to the first target RS resource group in the first RS resource group; and in step S5105, as a response to the action of receiving a second signaling, performs radio link monitoring only according to a second target RS resource group in the second RS resource group; and in step S5106, as a response to the action of receiving a second signaling, resets a count of first-type indication(s); and in step S5107, as a response to the action of receiving a second signaling, stops a first-type timer, the first-type timer being related to a link failure.

The second node N02 transmits a first signaling in step S5201; transmits a third signaling in step S5202; and transmits a second signaling in step S5203.

The third node N03 transmits a second signaling in step S5301.

In Embodiment 5, the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; any RS resource in the second target RS resource group belongs to the second RS resource group; the second target RS resource group is used for radio link monitoring; the first PCI is different from the second PCI.

In one embodiment, the second node N02 is a maintenance base station for a serving cell of the first node U01.

In one embodiment, the second node N02 and the third node N03 are two different TRPs.

In one embodiment, the second node N02 and the third node N03 belong to two different base stations.

In one embodiment, the second node N02 and the third node N03 belong to a same base station.

In one embodiment, the second node N02 and the third node N03 are two different UEs.

In one embodiment, the first node U01 receives a BCCH via the second node N02.

In one embodiment, the first node U01 receives a SIB via the second node N02.

In one embodiment, the first node U01 does not receive a BCCH via the third node N03.

In one embodiment, the first node U01 does not receive a SIB via the third node N03.

In one embodiment, the dotted-line box F5.1 is optional.

In one subembodiment, the dotted-line box F5.1 exists.

In one subembodiment, the dotted-line box F5.1 does not exist.

In one embodiment, the dotted-line box F5.2 is optional.

In one embodiment, the dotted-line box F5.3 is optional.

In one embodiment, the dotted-line box F5.4 is optional.

In one embodiment, the dotted-line box F5.5 is optional.

In one embodiment, the dotted-line box F5.6 is optional.

In one subembodiment, the dotted-line box F5.6 exists.

In one subembodiment, the dotted-line box F5.6 does not exist.

In one embodiment, at least one of the dotted-line box F5.4 or the dotted-line box F5.5 exists.

In one embodiment, one of the dotted-line box F5.2 or the dotted-line box F5.3 exists.

In one subembodiment, the dotted-line box F5.2 exists, while the dotted-line box F5.3 does not exist.

In one subembodiment, the dotted-line box F5.2 does not exist, while the dotted-line box F5.3 exists.

In one embodiment, the third signaling and the first signaling belong to a same RRC message.

In one embodiment, the third signaling and the first signaling belong to two different RRC messages.

In one embodiment, the third signaling and the first signaling belong to two different IEs in a same RRC message.

In one embodiment, the third signaling comprises a Downlink (DL) signaling.

In one embodiment, the third signaling comprises a Sidelink (SL) signaling.

In one embodiment, the third signaling is an RRC message.

In one embodiment, the third signaling comprises at least one RRC message.

In one embodiment, the third signaling comprises at least one Information Element (IE) in an RRC message.

In one embodiment, the third signaling comprises at least one Field in an RRC message.

In one embodiment, the third signaling is a field or an IE other than an IE RadioLinkMonitoringConfig.

In one embodiment, the third signaling comprises at least one IE other than an IE RadioLinkMonitoringConfig.

In one embodiment, at least one IE or at least one field in the third signaling other than an IE RadioLinkMonitoringConfig indicates the second RS resource group.

In one subembodiment, the third signaling comprises a ControlResourceSet IE, with at least one field in the ControlResourceSet IE indicating the second RS resource group.

In one subembodiment, the third signaling comprises a TCI-State IE, with at least one field in the TCI-State IE indicating the second RS resource group.

In one subembodiment, the third signaling comprises at least one referenceSignal field, the at least one referenceSignal field indicating the second RS resource group.

In one embodiment, an IE RadioLinkMonitoringConfig in the third signaling is used for indicating the second RS resource group.

In one embodiment, the third signaling comprises N sub-signaling(s), of which each sub-signaling comprises an IE RadioLinkMonitoringConfig, N being a number of BWP(s).

In one embodiment, the third signaling comprises at least one IE RadioLinkMonitoringConfig.

In one embodiment, the third signaling comprises at least a failureDetectionResourcesToAddModList field.

In one embodiment, the third signaling is a failureDetectionResourcesToAddModList field.

In one embodiment, a RadioLinkMonitoringRS field in the third signaling is used for configuring an RS in the second RS resource group.

In one embodiment, a detectionResource field in the third signaling is used for configuring an index of any RS resource of the at least one RS resource in the second RS resource group.

In one embodiment, a detectionResource field in the third signaling is used for configuring a type of any RS resource of the at least one RS resource in the second RS resource group.

In one embodiment, a detectionResource field in the third signaling is used for configuring a type and an index of any RS resource of the at least one RS resource in the second RS resource group.

In one embodiment, the third signaling is used for configuring a set of resource indexes, the set of resource indexes being used to determine the second RS resource group.

In one embodiment, a csi-RS-Index in the third signaling is used to determine a CSI-RS resource configuration index, or a ssb-Index in the third signaling is used to determine a SS/PBCH block index.

In one embodiment, the phrase of the third signaling used for configuring a second RS resource group comprises that: the third signaling is used to determine any RS resource in the second RS resource group.

In one embodiment, the phrase of the third signaling used for configuring a second RS resource group comprises that: the third signaling is used to determine an index of each RS resource in the second RS resource group.

In one embodiment, the phrase of the third signaling used for configuring a second RS resource group comprises that: the third signaling is used to determine a type of each RS resource in the second RS resource group.

In one embodiment, the phrase of the third signaling used for configuring a second RS resource group comprises that: the third signaling being used to determine an index and a type of each RS resource in the second RS resource group.

In one embodiment, the phrase of all RS resources in the second RS resource group being associated with a second PCI comprises that: the second PCI is used for generating a reference signal corresponding to all RS resources in the second RS resource group.

In one embodiment, the phrase of all RS resources in the second RS resource group being associated with a second PCI comprises that: all RS resources in the second RS resource group are QCL with the cell identified by the second PCI.

In one embodiment, the phrase of all RS resources in the second RS resource group being associated with a second PCI comprises that: the reference signal in the cell identified by the second PCI is transmitted using an RS resource in the second RS resource group.

In one embodiment, the phrase of all RS resources in the second RS resource group being associated with a second PCI comprises that: all RS resources in the second RS resource group are for the second PCI configuration.

In one embodiment, the phrase of all RS resources in the second RS resource group being associated with a second PCI comprises that: all RS resources in the second RS resource group belonging to the cell identified by the second PCI.

In one embodiment, the phrase of all RS resources in the second RS resource group being associated with a second PCI comprises that: the cell identified by the second PCI transmits a reference signal on RS resources in the second RS resource group.

In one embodiment, the phrase of all RS resources in the second RS resource group being associated with a second PCI comprises that: at least one RS resource in the second RS resource group is used for the cell identified by the second PCI transmitting a reference signal.

In one embodiment, as a response to the action of receiving a second signaling, radio link monitoring is performed only according to the second target RS resource group in the second RS resource group.

In one embodiment, the second RS resource group comprises at least one RS resource.

In one embodiment, the second RS resource group comprises one RS resource.

In one embodiment, the second RS resource group comprises more than one RS resource.

In one embodiment, the second RS resource group comprises one or more than one RS resource.

In one embodiment, a number of RS resource(s) in the second RS resource group is configurable.

In one embodiment, the sentence of “performing radio link monitoring only according to the second target RS resource group in the second RS resource group” includes: performing radio link monitoring according to the second target RS resource group in the second RS resource group within an evaluation period.

In one embodiment, the sentence of “performing radio link monitoring only according to the second target RS resource group in the second RS resource group” includes: performing radio link monitoring according to a measurement of the second target RS resource group in the second RS resource group.

In one embodiment, the sentence of “performing radio link monitoring only according to the second target RS resource group in the second RS resource group” includes: the second target RS resource group in the second RS resource group is used for performing radio link monitoring.

In one embodiment, the sentence of “performing radio link monitoring only according to the second target RS resource group in the second RS resource group” includes: all RS resources in the second target RS resource group in the second RS resource group are used for radio link monitoring.

In one embodiment, the sentence of “performing radio link monitoring only according to the second target RS resource group in the second RS resource group” includes: part of RS resources in the second target RS resource group in the second RS resource group are used for radio link monitoring.

In one embodiment, the sentence of “performing radio link monitoring only according to the second target RS resource group in the second RS resource group” includes: performing radio link monitoring according to the N3 RS resources in the second target RS resource group.

In one embodiment, the sentence of “performing radio link monitoring only according to the second target RS resource group in the second RS resource group” includes: performing radio link monitoring according to a measurement of the N3 RS resources in the second target RS resource group.

In one embodiment, the sentence of “performing radio link monitoring only according to the second target RS resource group in the second RS resource group” includes: determining according to the second target RS resource group whether a beam failure or a cell level radio link failure is monitored.

In one embodiment, the sentence of “performing radio link monitoring only according to the second target RS resource group in the second RS resource group” includes: RS resources other than the second RS resource group are not used for performing radio link monitoring.

In one embodiment, the sentence of “performing radio link monitoring only according to the second target RS resource group in the second RS resource group” includes: RS resources other than the second target RS resource group in the second RS resource group are not used for performing radio link monitoring.

In one embodiment, the phrase of any RS resource in the second target RS resource group belonging to the second RS resource group comprises that: all RS resources in the second target RS resource group are all or part of all RS resources in the second RS resource group.

In one embodiment, the phrase of any RS resource in the second target RS resource group belonging to the second RS resource group comprises that: any RS resource in the second target RS resource group is identical to an RS resource in the second RS resource group.

In one embodiment, the phrase of any RS resource in the second target RS resource group belonging to the second RS resource group comprises that: the second target RS resource group is identical to the second RS resource group.

In one embodiment, the phrase of any RS resource in the second target RS resource group belonging to the second RS resource group comprises that: the second target RS resource group is a subset in the second RS resource group.

In one embodiment, the first PCI is associated with the first cell, while the second PCI is associated with the second cell.

In one embodiment, the first PCI is associated with the second cell, while the second PCI is associated with the first cell.

In one embodiment, the first PCI is a PCI of the first cell, while the second PCI is a PCI of the second cell.

In one embodiment, the first PCI is a PCI of the second cell, while the second PCI is a PCI of the first cell.

In one embodiment, the phrase that the first PCI is different from the second PCI includes: the first PCI is unequal to the second PCI.

In one embodiment, a PCI is an integer.

In one embodiment, a PCI is identified by an IE PhysCellId.

In one embodiment, a PCI is used for identifying a physical cell.

In one embodiment, as a response to the action of receiving a second signaling, stop a first-type timer.

In one embodiment, the meaning of stopping a timer includes: the timer does not continue running.

In one embodiment, the meaning of stopping a timer includes: time count of the timer is cleared.

In one embodiment, the meaning of stopping a timer includes: time count of the timer is not incremented.

In one embodiment, the meaning of stopping includes: to stop.

In one embodiment, the meaning of stopping includes: to suspend.

In one embodiment, the phrase of the first-type timer being related to a link failure includes: the first-type timer is related to the link failure.

In one embodiment, the phrase of the first-type timer being related to a link failure includes: the first-type timer is used to determine the link failure.

In one embodiment, the phrase of the first-type timer being related to a link failure includes: the first-type timer is used to trigger the link failure.

In one embodiment, the phrase of the first-type timer being related to a link failure includes: the first-type timer is used to avoid the link failure.

In one embodiment, the first-type timer includes a T310.

In one embodiment, the first-type timer includes a T312.

In one embodiment, the first-type timer includes a t-PollRetransmit.

In one embodiment, the first-type timer includes a beamFailureDetectionTimer.

In one embodiment, each timer or counter mentioned in the present application is for a same cell group.

In one embodiment, each timer or counter mentioned in the present application is only related to one of an MCG or an SCG.

In one embodiment, as a response to the action of receiving the second signaling, perform: at least one of resetting a count of the first indication(s) in the present application, or resetting a count of the second indication(s) in the present application or resetting a count of the third indication(s) in the present application.

In one embodiment, as a response to the action of receiving the second signaling, perform: at least one of stopping the first timer in the present application, or stopping the second timer in the present application, or stopping the third timer in the present application.

In one embodiment, as a response to the action of receiving the second signaling, perform: at least one of resetting a count of the first indication(s) in the present application, or resetting a count of the second indication(s) in the present application or resetting a count of the third indication(s) in the present application, or stopping the first timer in the present application, or stopping the second timer in the present application, or stopping the third timer in the present application.

### Embodiment 6

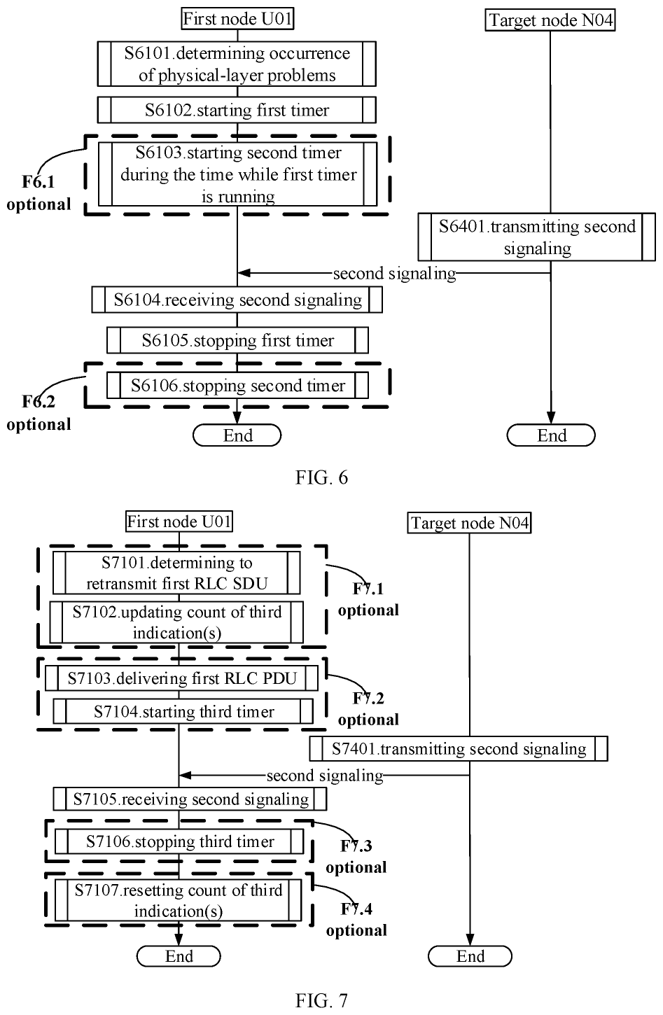

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

A first node U01 determines the occurrence of physical-layer problems in step S6101; and starts a first timer as a response to the action of determining the occurrence of physical-layer problems in step S6102; and starts a second timer during the time while the first timer is running in step S6103; receives a second signaling in step S6104; and stops the first timer as a response to the action of receiving the second signaling in step S6105; and stops the second timer as a response to the action of receiving the second signaling in step S6106.

A target node N04 transmits a second signaling in step S6401.

In Embodiment 6, the first timer is maintained in the RRC layer; the first-type timer includes the first timer.

In one embodiment, the target node is the second node.

In one embodiment, the target node is the third node.

In one embodiment, the dotted-line box F6.1 is optional.

In one embodiment, the dotted-line box F6.2 is optional.

In one embodiment, neither of the dotted-line box F6.1 and the dotted-line box F6.2 exists.

In one embodiment, the dotted-line box F6.1 exists and the dotted-line box F6.2 does not exist.

In one embodiment, the dotted-line box F6.1 exists and the dotted-line box F6.2 exists.

In one embodiment, it is determined that physical-layer problems occur according to radio link monitoring.

In one embodiment, the action of determining the occurrence of physical-layer problems comprises: determining that physical-layer problems occur in the SpCell.

In one embodiment, the action of determining the occurrence of physical-layer problems comprises: detecting the physical-layer problems.

In one embodiment, the action of determining the occurrence of physical-layer problems comprises: receiving N310 out-of-sync indications and none of T300, T301, T304, T311, T316 and T319 being running.

In one embodiment, the action of determining the occurrence of physical-layer problems comprises: receiving a first integer number of the first indications in a row and none of T300, T301, T304, T311, T316 and T319 being running.

In one subembodiment, the first integer is N310.

In one subembodiment, the first integer is configurable.

In one subembodiment, the first integer is configured by an RRC message.

In one subembodiment, the first indication is an out-of-sync indication.

In one embodiment, as a response to the action of determining the occurrence of physical-layer problems includes: when it is determined that physical-layer problems occur.

In one embodiment, as a response to the action of determining the occurrence of physical-layer problems includes: if it is determined that physical-layer problems occur.

In one embodiment, the first timer is T310.

In one embodiment, the first timer is associated with a Master Cell Group (MCG).

In one embodiment, the first timer is associated with a PCell.

In one embodiment, the first timer is associated with a Secondary Cell Group (SCG).

In one embodiment, the first timer is associated with a PScell.

In one embodiment, the phrase that the first timer is maintained in the RRC layer includes: the first timer being an RRC layer timer.

In one embodiment, the phrase that the first timer is maintained in the RRC layer includes: the first timer running in an RRC layer.

In one embodiment, the phrase that the first-type timer includes the second timer comprises that: the second timer is a first-type timer.

In one embodiment, the phrase that the first-type timer includes the second timer comprises that: the second timer belongs to the first-type timers.

In one embodiment, during the time while the first timer is running, start a second timer.

In one embodiment, the phrase during the time while the first timer is running includes: when the first timer is running.

In one embodiment, the phrase during the time while the first timer is running includes: if the first timer is running.

In one embodiment, during the time while the first timer is running, if a measurement report trigger event is satisfied and the second timer is not running, start a second timer.

In one embodiment, during the time while the first timer is running, if a measurement report trigger event is satisfied and the second timer is running, do not start a second timer.

In one embodiment, during the time while the first timer is running, if a measurement report trigger event is satisfied, start a second timer; where when the measurement report trigger event is satisfied, the second timer is not running.

In one embodiment, the measurement report trigger event being satisfied means that a measurement report is triggered.

In one embodiment, the measurement report trigger event being satisfied means that at least one of an Entering condition for Event A3 in Section 5.5.4.4, or an Entering condition for Event A4 in Section 5.5.4.5 or an Entering condition for Event A5 in Section 5.5.4.6 of the 3GPP TS 38.331 is satisfied.

In one embodiment, upon reception of the first notification, if the first timer is running, stop the first timer.

In one embodiment, upon reception of the second signaling, if the first timer is running, stop the first timer.

In one embodiment, upon reception of the first notification, if the second timer is running, stop the second timer.

In one embodiment, upon reception of the second signaling, if the second timer is running, stop the second timer.

In one embodiment, the second timer is T312.

In one embodiment, the second timer is T316.

In one embodiment, the action of starting a timer includes: starting the timer, the timer including a first-type timer.

In one embodiment, the action of starting a timer includes: restarting the timer, the timer including a first-type timer.

In one embodiment, the action of starting a timer includes: starting or restarting the timer, the timer including a first-type timer.

### Embodiment 7

Embodiment 7 illustrates a flowchart of signal transmission according to a third embodiment of the present application, as shown in FIG. 7. It should be particularly noted that the sequence illustrated herein does not set any limit to the signal transmission order or implementation order in the present application.

The first node U01 determines to retransmit a first RLC SDU in step S7101; and in step S7102, updates a count of third indication(s) as a response to the action of determining to retransmit the first RLC SDU; and in step S7103, delivers a first Radio Link Control (RLC) Protocol Data Unit (PDU), the first RLC PDU including a polling indication; and in step S7104, starts a third timer along with the action of delivering a first RLC PDU; and receives a second signaling in step S7105; and in step S7106, stops the third timer as a response to the action of receiving the second signaling; and in step S7107, resets a count of third indication(s) as a response to the action of receiving the second signaling.

The target node N04 transmits a second signaling in step S7401.

In Embodiment 7, the count of the third indication(s) is used to determine a number of times the first RLC SDU has been retransmitted; the first-type indication includes the third indication; expiration of the third timer is used to determine a retransmission of a polling indication; the first-type timer includes the third timer.

In one embodiment, the dotted-line box F7.1 is optional.

In one embodiment, the dotted-line box F7.1 exists.

In one embodiment, the dotted-line box F7.1 does not exist.

In one embodiment, the dotted-line box F7.2 is optional.

In one embodiment, the dotted-line box F7.2 exists.

In one embodiment, the dotted-line box F7.2 does not exist.

In one embodiment, the dotted-line box F7.3 is optional.

In one embodiment, the dotted-line box F7.3 exists.

In one embodiment, the dotted-line box F7.3 does not exist.

In one embodiment, the dotted-line box F7.4 is optional.

In one embodiment, the dotted-line box F7.4 exists.

In one embodiment, the dotted-line box F7.4 does not exist.

In one embodiment, after the step S7104 and till the step S7106, the third timer is continuously running.

In one embodiment, after the step S7104 and till the step S7106, the third timer is not stopped.

In one embodiment, after the step S7104 and till the step S7106, time count of the third timer does not reach an expiration value of the third timer.

In one embodiment, after the step S7102 and till the step S7107, the count of the third indication(s) is not reset.

In one embodiment, after the step S7102 and till the step S7107, the count of the third indication(s) is not incremented.

In one embodiment, after the step S7102 and till the step S7107, the count of the third indication(s) does not reach a third value.

In one embodiment, the action of delivering a first RLC PDU includes: transmitting the first RLC PDU via an air interface.

In one embodiment, the action of delivering a first RLC PDU includes: delivering the first RLC PDU to a lower layer.

In one embodiment, the action of delivering a first RLC PDU includes: the first node U01 delivering the first RLC PDU to a MAC layer from an RLC layer.

In one embodiment, the first RLC PDU comprises an RLC PDU.

In one embodiment, the first RLC PDU is an Acknowledged Mode Data (AMD) PDU.

In one embodiment, the first RLC PDU is an RLC-layer PDU.

In one embodiment, the first RLC PDU is an RLC data PDU.

In one embodiment, the first RLC PDU comprises a Data field.

In one embodiment, the first RLC PDU comprises an AMD PDU header.

In one embodiment, for the structure of the first RLC PDU, refers to section 6.2.2.4 of 3GPP TS 38.322.

In one embodiment, an AMD PDU header in the first RLC PDU comprises a P field, the P field comprising 1 bit; herein, the P field being set to 1 indicates that a STATUS report has been requested and the P field being set to 0 indicates that a STATUS report has not been requested.

In one embodiment, the polling indication is used to request a status report.

In one embodiment, the polling indication is configured via the Polling bit (P) field.

In one embodiment, the phrase of the first RLC PDU including a polling indication comprises that: a polling indication is set in the first RLC PDU.

In one embodiment, the phrase of the first RLC PDU including a polling indication comprises that: the P field in the AMD PDU header in the first RLC PDU is set to 1.

In one embodiment, along with the action of delivering the first RLC PDU, a transmitting end of the AM RLC entity starts a third timer.

In one embodiment, the action of starting a third timer includes: starting the third timer.

In one embodiment, the action of starting a third timer includes: restarting the third timer.

In one embodiment, the action of starting a third timer includes: starting or restarting the third timer.

In one embodiment, along with the action of delivering the first RLC PDU, start the third timer if the third timer is not running.

In one embodiment, along with the action of delivering the first RLC PDU, restart the third timer if the third timer is running.

In one embodiment, the third timer is a t-PollRetransmit.

In one embodiment, the third timer is an RLC layer timer.

In one embodiment, the third timer is maintained in an RLC layer.

In one embodiment, reception of a status report containing a positive or negative acknowledgement of an RLC SDU with sequence number POLL_SN is used to determine to stop and reset the third timer.

In one embodiment, upon reception of the first notification, if the third timer is running, stop the third timer.

In one embodiment, upon reception of the second signaling, if the third timer is running, stop the third timer.

In one embodiment, the phrase that expiration of the third timer is used to determine a retransmission of a polling indication comprises that: the expiration of the third timer is used to determine a retransmission of an AMD PDU containing the polling indication.

In one embodiment, the phrase that expiration of the third timer is used to determine a retransmission of a polling indication comprises that: the expiration of the third timer is used to determine a transmission of an AMD PDU containing the polling indication.

In one embodiment, the phrase that expiration of the third timer is used to determine a retransmission of a polling indication comprises that: the expiration of the third timer is used to determine a re-quest of a status report.

In one embodiment, the action of determining to retransmit a first RLC SDU includes: considering retransmission of the first RLC SDU; herein, a negative acknowledgement is received for the first RLC SDU.

In one subembodiment, the SN of the first RLC SDU is not less than TX_Next_Ack and is not greater than the highest SN of AMD PDU among AMD PDUs delivered to a lower layer.

In one subembodiment, the negative acknowledgement is received via a status report (STATUS PDU) from a peer AM RLC entity.

In one embodiment, the action of determining to retransmit a first RLC SDU includes: considering retransmitting the first RLC SDU upon expiration of the third timer; where the first RLC SDU is an RLC SDU with the highest SN among RLC SDUs delivered to a lower layer, or, the first RLC SDU is any one of the RLC SDUs that is not correctly acknowledged.

In one subembodiment, both the transmit buffer and retransmit buffer are empty (except for transmitted RLC SDUs or RLC SDU segments awaiting acknowledgement).

In one subembodiment, new RLC SDUs or RLC SDU segments cannot be transmitted.

In one subsidiary embodiment of the above subembodiment, a transmission window being stalling leads to that a new RLC SDU or a new segment of RLC SDU cannot be transmitted.

In one subsidiary embodiment of the above subembodiment, a retransmission window being stalling leads to that a new RLC SDU or a new segment of RLC SDU cannot be transmitted.

In one embodiment, the first RLC SDU is an RLC SDU.

In one embodiment, the first RLC SDU is an RLC SDU segment.

In one embodiment, the first RLC SDU is a segment of an RLC SDU.

In one embodiment, the first RLC SDU is an RLC SDU or an RLC SDU segment.

In one embodiment, the first RLC PDU comprises the first RLC SDU.

In one embodiment, the first RLC PDU comprises a segment of the first RLC SDU.

In one embodiment, a count of the third indication(s) is for the first RLC SDU.

In one embodiment, a counter RETX_COUNT is used for calculating the count of the third indication(s).

In one embodiment, a counter RETX_COUNT is equal to the count of the third indication(s).

In one embodiment, the count of the third indication(s) refers to a value of a counter RETX_COUNT.

In one embodiment, the action of updating the count of the third indication(s) includes: updating the counter RETX_COUNT.

In one embodiment, the action of updating the count of the third indication(s) includes: setting the count of the third indication(s) to 0.

In one embodiment, the action of updating the count of the third indication(s) includes: incrementing the count of the third indication(s) by 1.

In one embodiment, the sentence “updates a count of third indication(s) as a response to the action of determining to retransmit the first RLC SDU” comprises that: as a response to the action of determining to retransmit the first RLC SDU, if the first RLC SDU is considered to be retransmitted for the first time, set the count of the third indication(s) associated with the first RLC SDU to 0 (zero).

In one embodiment, the sentence “updates a count of third indication(s) as a response to the action of determining to retransmit the first RLC SDU” comprises that: as a response to the action of determining to retransmit the first RLC SDU, if the first RLC SDU is not considered to be retransmitted for the first time, increment the count of the third indication(s).

In one embodiment, the sentence “updates a count of third indication(s) as a response to the action of determining to retransmit the first RLC SDU” comprises that: as a response to the action of determining to retransmit the first RLC SDU, if the first RLC SDU is not considered to be retransmitted for the first time and the first RLC SDU is not pending for retransmission already, and the count of the third indication(s) associated with the first RLC SDU has not been incremented due to another negative acknowledgment in the same STATUS PDU, increment the count of the third indication(s).

In one embodiment, the count of the third indication(s) reaching a third value is used to indicate to a higher layer that a maximum number of retransmissions has been reached.

In one subembodiment, that the higher layer has received the indication that a maximum number of retransmissions has been reached is used to trigger a Radio Link Failure (RLF).

In one subembodiment, the third value includes a maxRetxThreshold.

In one subembodiment, the third value is configurable.

In one subembodiment, the third value is configured via an RRC message.

In one subembodiment, the third value is a non-negative integer.

In one embodiment, the phrase that the count of the third indication(s) is used to determine a number of times the first RLC SDU has been retransmitted comprises that: the count of the third indication(s) is equal to a number of times the first RLC SDU has been retransmitted.

In one embodiment, the phrase that the count of the third indication(s) is used to determine a number of times the first RLC SDU has been retransmitted comprises that: the count of the third indication(s) is used to count a number of times the first RLC SDU has been retransmitted.

In one embodiment, the phrase that the count of the third indication(s) is used to determine a number of times the first RLC SDU has been retransmitted comprises that: the count of the third indication(s) counts a number of retransmissions of the first RLC SDU.

In one embodiment, the number of times means: the number.

In one embodiment, the number of times means: the quantity.

### Embodiment 8

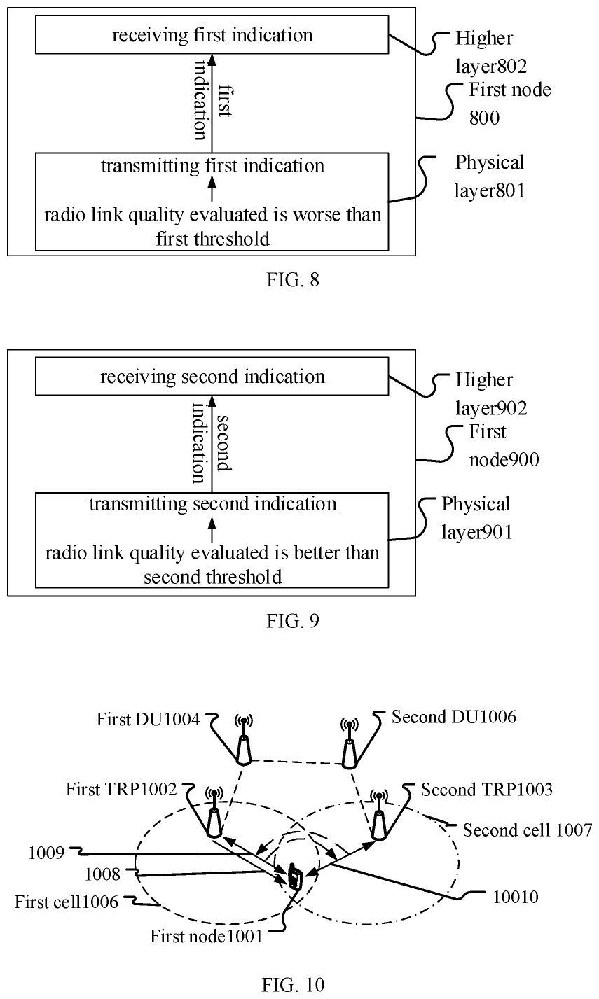

Embodiment 8 illustrates a schematic diagram of a physical layer of a first node reporting a first indication to a higher layer of the first node according to one embodiment of the present application, as shown in FIG. 8.

In Embodiment 8, each time when a radio link quality evaluated is worse than a first threshold, a physical layer 801 of the first node 800 reports a first indication to a higher layer 802 of the first node 800; the first-type indication includes the first indication; the first threshold is configurable.

In one embodiment, after the physical layer 801 of the first node 800 reports a first indication to the higher layer 802 of the first node 800, the higher layer 802 of the first node 800 receives the first indication; as a response to the action that the higher layer 802 of the first node 800 receives the first indication, update a count of the first indication(s).

In one embodiment, after the physical layer 801 of the first node 800 reports a first indication to the higher layer 802 of the first node 800, the higher layer 802 of the first node 800 receives the first indication; as a response to the action that the higher layer 802 of the first node 800 receives a first indication, determine whether to update a count of the first indication(s) according to whether a first timer is running; the action of determining whether to update a count of the first indication(s) according to whether the first timer is running includes: when the first timer is running, not updating the count of the first indication(s); when the first timer is not running, updating the count of the first indication(s).

In one embodiment, the action of updating the count of the first indication(s) includes: incrementing the count of the first indication(s) by 1.

In one embodiment, the action of updating the count of the first indication(s) includes: incrementing a counter N310 by 1, the counter N310 used for calculating the count of the first indication(s).

In one embodiment, the action of not updating the count of the first indication(s) includes: keeping the count of the first indication(s).

In one embodiment, the action of not updating the count of the first indication(s) includes: not incrementing a counter N310.

In one embodiment, if the count of the first indication(s) reaches a first value, start the first timer.

In one subembodiment, the first value is equal to a constant N310.

In one subembodiment, the first value is equal to beamFailureInstanceMaxCount.

In one subembodiment, the first value is a constant.

In one subembodiment, the first value is configurable.

In one subembodiment, the first value is a positive integer, and the first value is no greater than 64.

In one subembodiment, the first value is a maximum value of the count of the first indication(s).

In one embodiment, the phrase each time when a radio link quality evaluated is worse than a first threshold includes: once an evaluated radio link quality is worse than the first threshold.

In one embodiment, the phrase each time when a radio link quality evaluated is worse than a first threshold includes: as long as an evaluated radio link quality is worse than the first threshold.

In one embodiment, the phrase each time when a radio link quality evaluated is worse than a first threshold includes: if an evaluated radio link quality is worse than the first threshold.

In one embodiment, the phrase that a radio link quality evaluated is worse than a first threshold includes: radio link quality of each RS resource in a target observation set is worse than the first threshold.

In one embodiment, the phrase that a radio link quality evaluated is worse than a first threshold includes: radio link qualities of all RS resources in a target observation set are worse than the first threshold.

In one embodiment, the phrase that a radio link quality evaluated is worse than a first threshold includes: the radio link quality evaluated according to each RS resource in a target observation set is worse than the first threshold.

In one embodiment, the first threshold is configurable.

In one embodiment, the first threshold is pre-configured.

In one embodiment, the first threshold is configured via an RRC message.

In one embodiment, the first threshold includes a Block Error Ratio (BLER) threshold.

In one embodiment, the first threshold includes a Reference Signal Received Power (RSRP) threshold.

In one embodiment, the first indication is an out-of-sync indication.

In one subembodiment, the first threshold includes Qₒᵤₜ.

In one subembodiment, the first threshold is indicated by a field in an RRC message.

In one subembodiment, the first threshold is indicated by a field in an RRC message, where a name of the field includes rlmInSyncOutOfSyncThreshold.

In one embodiment, the first indication is a beam failure instance indication.

In one subembodiment, the first threshold includes Q_{out,LR}.

In one subembodiment, the first threshold is indicated by a field in an RRC message.

In one subembodiment, the first threshold is indicated by a field in an RRC message, where a name of the field includes at least one of rlmInSyncOutOfSyncThreshold, or rsrp-ThresholdSSB, or rsrp-ThresholdBFR-r16, or rsrp-ThresholdBFR.

In one embodiment, each time when a radio link quality evaluated is worse than a first threshold, a physical layer 801 of the first node 800 reports a first indication to a higher layer 802 of the first node 800; as a response to that the higher layer 802 of the first node 800 receives the first indication, update a count of the first indication(s).

In one embodiment, the higher layer 802 is a MAC layer.

In one embodiment, the higher layer 802 is an RRC layer.

In one embodiment, FIG. 8 is presented only for the purpose of explaining that the physical layer 801 and the higher layer 802 belong to the first node 800; the first node 800 also comprises protocol layers or parts other than the physical layer 801 and the higher layer 802.

### Embodiment 9

Embodiment 9 illustrates a schematic diagram of a physical layer of a first node reporting a second indication to a higher layer of the first node according to one embodiment of the present application, as shown in FIG. 9.

In Embodiment 9, each time a radio link quality evaluated is better than a second threshold, a physical layer 901 of the first node 900 reports a second indication to a higher layer 902 of the first node 900; the first-type indication includes the second indication; the second threshold is configurable.

In one embodiment, after the physical layer 901 of the first node 900 has reported a second indication to a higher layer 902 of the first node 900, the higher layer 902 of the first node 900 receives the second indication; as a response to the action that the higher layer 902 of the first node 900 receives a second indication, update a count of the second indication(s).

In one embodiment, after the physical layer 901 of the first node 900 has reported a second indication to a higher layer 902 of the first node 900, the higher layer 902 of the first node 900 receives the second indication; as a response to the action that the higher layer 902 of the first node 900 receives a second indication, determine whether to update a count of the second indication(s) according to whether a first timer is running; the action of determining whether to update a count of the second indication(s) according to whether the first timer is running includes: when the first timer is running, updating the count of the second indication(s); when the first timer is not running, not updating the count of the second indication(s).

In one embodiment, the action of not updating the count of the second indication(s) includes: keeping the count of the second indication(s).

In one embodiment, the action of not updating the count of the second indication(s) includes: not incrementing a counter N311.

In one embodiment, the action of updating the count of the second indication(s) includes: incrementing the count of the second indication(s) by 1.

In one embodiment, the action of updating the count of the second indication(s) includes: incrementing a counter N311 by 1, the counter N311 being used for calculating the count of the second indication(s).

In one embodiment, if the count of the second indications successively received reaches a second value, stop the first timer.

In one subembodiment, the second value is equal to a constant N311.

In one subembodiment, the second value is a constant.

In one subembodiment, the second value is configurable.

In one subembodiment, the second value is a positive integer, and the second value is no greater than 64.

In one subembodiment, the second value is a maximum value of the count of the second indication(s).

In one embodiment, the first node 900 evaluates the radio link quality once per indication cycle for a period of time preceding the indication cycle.

In one embodiment, the phrase each time when a radio link quality evaluated is better than a second threshold includes: once an evaluated radio link quality is better than the second threshold.

In one embodiment, the phrase each time when a radio link quality evaluated is better than a second threshold includes: as long as an evaluated radio link quality is better than the second threshold.

In one embodiment, the phrase each time when a radio link quality evaluated is better than a second threshold includes: if an evaluated radio link quality is better than the second threshold.

In one embodiment, the phrase that a radio link quality evaluated is better than a second threshold includes: radio link quality of each RS resource in a target observation set is better than the second threshold.

In one embodiment, the phrase that a radio link quality evaluated is better than a second threshold includes: radio link qualities of all RS resources in a target observation set are better than the second threshold.

In one embodiment, the phrase that a radio link quality evaluated is better than a second threshold includes: the radio link quality evaluated according to each RS resource in a target observation set is better than the second threshold.

In one embodiment, the second threshold is configurable.

In one embodiment, the second threshold is pre-configured.

In one embodiment, the second threshold is configured via an RRC message.

In one embodiment, the second threshold comprises a BLER threshold.

In one embodiment, the second threshold comprises an RSRP threshold.

In one embodiment, the second threshold comprises Qᵢₙ.

In one embodiment, the second indication is an in-sync indication.

In one embodiment, the second threshold is indicated by a field in an RRC message.

In one subembodiment, a name of the field includes rlmInSyncOutOfSyncThreshold.

In one subembodiment, a name of the field includes rsrp-ThresholdSSB.

In one subembodiment, a name of the field includes rsrp-ThresholdBFR.

In one embodiment, the higher layer 902 is a MAC layer.

In one embodiment, the higher layer 902 is an RRC layer.

In one embodiment, FIG. 9 is presented only for the purpose of explaining that the physical layer 901 and the higher layer 902 belong to the first node 900; the first node 900 also comprises protocol layers or parts other than the physical layer 901 and the higher layer 902.

### Embodiment 10

Embodiment 10 illustrates a schematic diagram illustrating a relation between a second node and a third node according to one embodiment of the present application, as shown in FIG. 10.

In one embodiment, the second node comprises at least the first TRP 1002; the first TRP 1002 belongs to the first DU 1004; the first DU 1004 comprises part of the second node; the first TRP 1002 is part of the second node.

In one embodiment, the third node comprises at least the second TRP 1003; the second TRP 1003 belongs to the second DU 1005; the second DU 1005 comprises part of the third node; the second TRP 1003 is part of the third node.

In one embodiment, the second node comprises the first DU 1004.

In one embodiment, the third node comprises the second DU 1005.

In one embodiment, the first DU 1004 comprises a Distributed Unit (DU).

In one embodiment, the second DU 1005 comprises a DU.

In one embodiment, the first DU 1004 and the second DU 1005 are a same DU.

In one embodiment, the first DU 1004 and the second DU 1005 are two different DUs.

In one embodiment, beams of the first TRP 1002 and beams of the second TRP 1003 correspond to a same CORESET.

In one embodiment, beams of the first TRP 1002 and beams of the second TRP 1003 correspond to different CORESETs.

In one embodiment, the first cell 1006 is associated with the second node.

In one embodiment, the first cell 1006 is associated with one or more beams in the second node.

In one embodiment, the first cell 1006 is associated with one or more beams of the first TRP 1002.

In one embodiment, a maintenance base station of the first cell 1006 is the second node.

In one embodiment, the first cell 1006 is a physical cell.

In one embodiment, the first cell 1006 is a serving cell of the first node 1001, the serving cell referring to a Primary Cell (PCell) or a Primary Secondary Cell (PSCell) or a Secondary Cell (SCell).

In one embodiment, the second cell 1007 is associated with the third node.

In one embodiment, the second cell 1007 is associated with one or more beams in the third node.

In one embodiment, the second cell 1007 is associated with one or more beams of the second TRP 1003.

In one embodiment, a maintenance base station of the second cell 1007 is the third node.

In one embodiment, the second cell 1007 is a physical cell.

In one embodiment, the second cell 1007 provides extra physical resources on top of the first cell.

In one embodiment, the second cell 1007 is a configured candidate cell for L1/L2 mobility.

In one embodiment, the first cell 1006 and the second cell 1007 are intra-frequency.

In one embodiment, the first cell 1006 and the second cell 1007 are inter-frequency.

In one embodiment, the cell identified by the first PCI is the first cell 1006; the cell identified by the second PCI is the second cell 1007.

In one embodiment, the cell identified by the first PCI is the second cell 1007; the cell identified by the second PCI is the first cell 1006.

In one embodiment, the first cell 1006 is a primary cell (PCell) of the first node 1001, while the second cell 1007 is a neighboring cell of the PCell of the first node 1001.

In one embodiment, the first cell 1006 belongs to a serving cell of the first node 1001, while the second cell 1007 does not belong to the serving cell of the first node 1001.

In one embodiment, the first cell 1006 comprises a serving cell of the first node 1001, while the second cell 1007 comprises a neighboring cell of the first cell 1006.

In one embodiment, the first cell 1006 comprises a serving cell of the first node 1001, while the second cell 1007 comprises a non-serving cell of the first node 1001.

In one embodiment, when the second cell 1007 is configured, the first node 1001 keeps RRC_Connected with the first cell 1006; when the second cell 1007 is applied, a serving cell of the first node 1001 keeps unchanged.

In one subembodiment, the phrase that a serving cell of the first node 1001 keeps unchanged comprises that: the protocol stack of at least one of an RRC layer, or a PDCP layer, or an RLC layer, or a MAC layer or a PHY layer of the first node 1001 does not require relocation.

In one subembodiment, the phrase that a serving cell of the first node 1001 keeps unchanged comprises that: an RRC connection of the first node 1001 keeps unchanged.

In one subembodiment, the phrase that a serving cell of the first node 1001 keeps unchanged comprises that: a serving cell identifier of the first node 1001 keeps unchanged.

In one subembodiment, the phrase that a serving cell of the first node 1001 keeps unchanged comprises that: all or part of ServingCellConfigCommon configuration of the first node 1001 keeps unchanged.

In one subembodiment, the phrase that a serving cell of the first node 1001 keeps unchanged comprises that: all or part of ServingCellConfigCommonSIB configuration of the first node 1001 keeps unchanged.

In one embodiment, as the first node 1001 moves between the first cell 1006 and the second cell 1007, a serving cell of the first node 1001 keeps unchanged.

In one embodiment, there is RRC connection between the first node 1001 and the first cell 1006, while there is no RRC connection between the first node 1001 and the second cell 1007.

In one embodiment, the arrowhead 1008 indicates at least one of a BCCH, or a paging signal or system information.

In one embodiment, the arrowhead 1009 indicates at least one of a PUSCH or a PDSCH or a PDCCH.

In one embodiment, the arrowhead 1010 indicates at least one of a PUSCH or a PDSCH or a PDCCH.

In one embodiment, before the action of performing a first action set, the first node 1001 listens over a second PDCCH, the second PDCCH being associated with a Cell Radio Network Temporary Identifier (C-RNTI) of the cell identified by the second PCI; after the action of performing the first action set, the first node 1001 listens over a first PDCCH, the first PDCCH being associated with a C-RNTI of the cell identified by the first PCI.

In one embodiment, before the action of performing a first action set, a PUSCH resource or a PDSCH resource of the first node 1001 is associated with the cell identified by the second PCI; after the action of performing the first action set, a PUSCH resource or a PDSCH resource of the first node 1001 is associated with the cell identified by the first PCI.

In one embodiment, before the action of performing a first action set, a PUSCH resource or a PDSCH resource of the first node 1001 is associated with the cell identified by the second PCI; after the action of performing the first action set, a PUSCH resource or a PDSCH resource of the first node 1001 is associated with the cell identified by the first PCI and the cell identified by the second PCI.

In one embodiment, a PUSCH or PDSCH of the first node in the cell identified by the first PCI and a PUSCH or PDSCH of the first node in the cell identified by the second PCI are respectively associated with two different Radio Network Temporary Identifiers (RNTIs).

In one embodiment, either of the arrowhead 1009 and the arrowhead 1010 exists.

In one embodiment, both of the arrowhead 1009 and the arrowhead 1010 exist.

### Embodiment 11

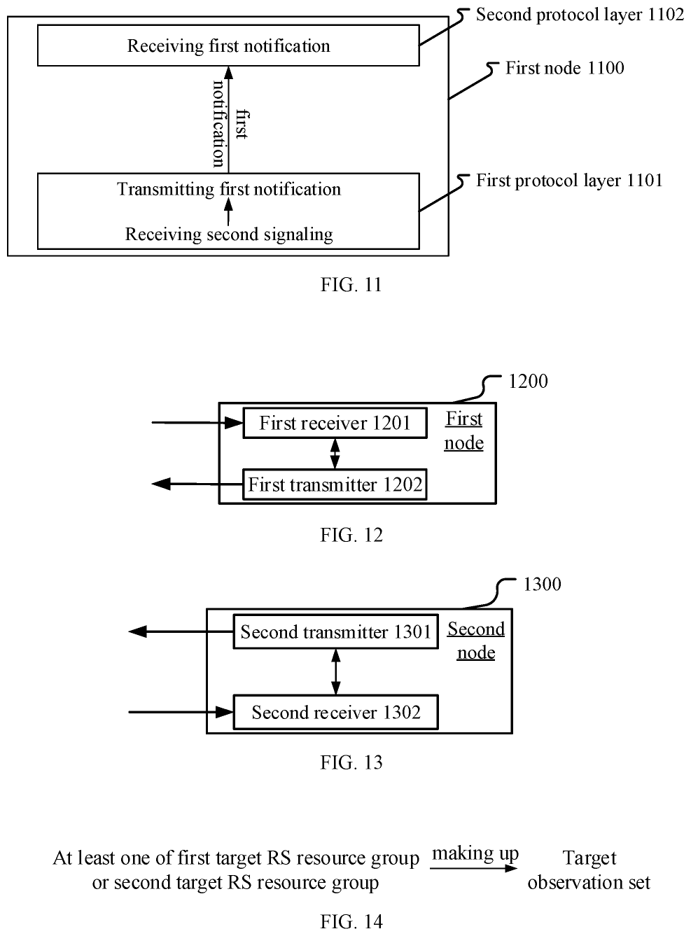

Embodiment 11 illustrates a schematic diagram of a first notification according to one embodiment of the present application, as shown in FIG. 11.

In Embodiment 11, the first action set includes: the first node 1100 transmitting a first notification from a first protocol layer 1101 to a second protocol layer 1102 where the first node 1100 is at; the first node 1100 receives the first notification at the second protocol layer 1102.

In one embodiment, the first notification is used to determine that the second signaling is received.

In one embodiment, the first notification is used to determine that the first node starts to apply radio resources of the cell identified by the first PCI.

In one embodiment, the action that the first node 1100 receives the first notification at the second protocol layer 1102 is used to trigger the action of stopping a first-type timer.

In one subembodiment, when the first node 1100 receives the first notification at the second protocol layer 1102, stop a first-type timer.

In one subembodiment, as a response to the action of receiving a second signaling, when the first node 1100 receives the first notification at the second protocol layer 1102, stop a first-type timer.

In one subembodiment, as a response to the action of receiving a second signaling, perform a first action set, the first action set including stopping a first-type timer; herein, the first action set includes: The first node 1100 transmits a first notification from a first protocol layer 1101 to a second protocol layer 1102 where the first node 1100 is at; the first node 1100 receives the first notification at the second protocol layer 1102; the action that the first node 1100 receives the first notification at the second protocol layer 1102 is used to trigger the action of stopping a first-type timer.

In one embodiment, the action that the first node 1100 receives the first notification at the second protocol layer 1102 is used to trigger the action of resetting a count of first-type indication(s).

In one subembodiment, when the first node 1100 receives the first notification at the second protocol layer 1102, reset the count of first-type indication(s).

In one subembodiment, as a response to the action of receiving a second signaling, when the first node 1100 receives the first notification at the second protocol layer 1102, reset the count of first-type indication(s).

In one subembodiment, as a response to the action of receiving a second signaling, perform a first action set, the first action set including resetting a count of first-type indication(s); herein, the first action set includes: the first node 1100 transmitting a first notification from a first protocol layer 1101 to a second protocol layer 1102 where the first node 1100 is at; the first node 1100 receives the first notification at the second protocol layer 1102; the action that the first node 1100 receives the first notification at the second protocol layer 1102 is used to trigger the action of resetting a count of first-type indication(s).

In one embodiment, the first protocol layer 1101 includes a MAC layer.

In one embodiment, the first protocol layer 1101 includes a physical layer.

In one embodiment, the second protocol layer 1102 includes an RLC layer.

In one embodiment, the second protocol layer 1102 includes an RRC layer.

In one embodiment, the first protocol layer 1101 is below the second protocol layer 1102.

In one embodiment, the first protocol layer 1101 is a lower layer of the second protocol layer 1102.

In one embodiment, the second protocol layer 1102 is an upper layer of the first protocol layer 1101.

In one embodiment, the first protocol layer 1101 is a physical layer, and the second protocol layer 1102 is a MAC layer.

In one embodiment, the first protocol layer 1101 is a physical layer, and the second protocol layer 1102 is an RRC layer.

In one embodiment, the first notification is an inter-protocol-layer message.

In one embodiment, the first notification is not an air-interface message.

In one embodiment, the first notification is conveyed internally in the first node 1100.

In one embodiment, FIG. 11 is presented only for explaining that the first protocol layer 1101 and the second protocol layer 1102 belong to the first node 1100; the first node 1100 also comprises protocol layers or parts other than the first protocol layer 1101 and the second protocol layer 1102.

### Embodiment 12

Embodiment 12 illustrates a structure block diagram of a processing device used in a first node according to one embodiment of the present application; as shown in FIG. 12. In FIG. 12, a processing device 1200 in a first node is comprised of a first receiver 1201 and a first transmitter 1202.

The first receiver 1201 receives a first signaling, the first signaling used for configuring a first Reference Signal (RS) resource group, with all RS resources in the first RS resource group being associated with a first Physical Cell Identity (PCI); and receives a second signaling, the second signaling used for determining a first target RS resource group, any RS resource in the first target RS resource group belonging to the first RS resource group; and performs a first action set as a response to the action of receiving the second signaling, the first action set including resetting a count of first-type indications.

In Embodiment 12, the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, the first receiver 1201 receives a third signaling, the third signaling used for configuring a second RS resource group, with all RS resources in the second RS resource group being associated with a second PCI; herein, the first action set includes: performing radio link monitoring only according to a second target RS resource group in the second RS resource group; any RS resource in the second target RS resource group belongs to the second RS resource group; the second target RS resource group is used for radio link monitoring; the first PCI is different from the second PCI.

In one embodiment, the first receiver 1201, each time when a radio link quality evaluated by which is worse than a first threshold, a physical layer of the first node reports a first indication to a higher layer of the first node; the first-type indication includes the first indication; the first threshold is configurable.

In one embodiment, the first receiver 1201, each time when a radio link quality evaluated by which is better than a second threshold, a physical layer of the first node reports a second indication to a higher layer of the first node; the first-type indication includes the second indication; the second threshold is configurable.

In one embodiment, the first action set includes stopping a first-type timer, the first-type timer being related to a link failure.

In one embodiment, the first receiver 1201 determines the occurrence of physical-layer problems; and starts a first timer as a response to the action of determining the occurrence of physical-layer problems; herein, the first timer is maintained in the RRC layer; the first-type timer includes the first timer.

In one embodiment, the first transmitter 1202 delivers a first RLC PDU, the first RLC PDU including a polling indication; and starts a third timer along with the action of delivering a first RLC PDU; herein, expiration of the third timer is used to determine a retransmission of a polling indication; the first-type timer includes the third timer.

In one embodiment, the first transmitter 1202 determines to retransmit a first RLC SDU; and updates a count of third indication(s) as a response to the action of determining to retransmit the first RLC SDU; herein, the count of the third indication(s) is used to determine a number of times the first RLC SDU has been retransmitted; the first-type indication includes the third indication.

In one embodiment, an RS resource for radio link monitoring is related to all RS resources in a target observation set, and the RS resource for radio link monitoring is unrelated to any RS resource other than the target observation set; the target observation set consists of at least one of the first target RS resource group or the second target RS resource group.

In one embodiment, the first receiver 1201 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises the antenna 452, the receiver 454, the multi-antenna receiving processor 458 and the receiving processor 456 in FIG. 4 of the present application.

In one embodiment, the first receiver 1201 comprises the antenna 452, the receiver 454 and the receiving processor 456 in FIG. 4 of the present application.

In one embodiment, the first transmitter 1202 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1202 comprises the antenna 452, the transmitter 454, the multi-antenna transmitting processor 457 and the transmitting processor 468 in FIG. 4 of the present application.

In one embodiment, the first transmitter 1202 comprises the antenna 452, the transmitter 454 and the transmitting processor 468 in FIG. 4 of the present application.

### Embodiment 13

Embodiment 13 illustrates a structure block diagram of a processing device used in a second node according to one embodiment of the present application; as shown in FIG. 13. In FIG. 13, a processing device 1300 in a second node is comprised of a second transmitter 1301 and a second receiver 1302.

The second transmitter 1301 transmits a first signaling, the first signaling used for configuring a first Reference Signal (RS) resource group, with all RS resources in the first RS resource group being associated with a first Physical Cell Identifier (PCI); and transmits a second signaling, the second signaling used for determining a first target RS resource group, any RS resource in the first target RS resource group belonging to the first RS resource group.

In Embodiment 13, as a response to the second signaling being received, a first action set is performed, the first action set including resetting a count of first-type indications; the first RS resource group comprises at least one RS resource; the first signaling is a Radio Resource Control (RRC) layer signaling; the second signaling is a signaling at protocol layer below the RRC layer; the first target RS resource group is used for radio link monitoring; the first-type indication is related to a link failure; the first action set includes: performing radio link monitoring only according to the first target RS resource group in the first RS resource group.

In one embodiment, the second transmitter 1301 transmits a third signaling, the third signaling used for configuring a second RS resource group, with all RS resources in the second RS resource group being associated with a second PCI; herein, the first action set includes: performing radio link monitoring only according to a second target RS resource group in the second RS resource group; any RS resource in the second target RS resource group belongs to the second RS resource group; the second target RS resource group is used for radio link monitoring; the first PCI is different from the second PCI.

In one embodiment, each time when a radio link quality evaluated is worse than a first threshold, a physical layer of a receiver of the first signaling reports a first indication to higher layers of the receiver of the first signaling; the first-type indication includes the first indication; the first threshold is configurable.

In one embodiment, each time when a radio link quality evaluated is better than a second threshold, a physical layer of a receiver of the first signaling reports a second indication to higher layers of the receiver of the first signaling; the first-type indication includes the second indication; the second threshold is configurable.

In one embodiment, the first action set includes stopping a first-type timer, the first-type timer being related to a link failure.

In one embodiment, it is determined that physical-layer problems have occurred in the receiver of the first signaling; as a response to that it is determined that the physical-layer problems have occurred in the receiver of the first signaling, a first timer is started; herein, the first timer is maintained in the RRC layer; the first-type timer includes the first timer.

In one embodiment, a first RLC PDU is delivered, the first RLC PDU including a polling indication; a third timer is started along with the action of delivering a first RLC PDU; herein, expiration of the third timer is used to determine a retransmission of a polling indication; the first-type timer includes the third timer.

In one embodiment, it is determined that a first RLC SDU is retransmitted; as a response to the first RLC SDU being determined to be retransmitted, a count of third indication(s) is updated; herein, the count of the third indication(s) is used to determine a number of times the first RLC SDU has been retransmitted; the first-type indication includes the third indication.

In one embodiment, an RS resource for radio link monitoring is related to all RS resources in a target observation set, and the RS resource for radio link monitoring is unrelated to any RS resource other than the target observation set; the target observation set consists of at least one of the first target RS resource group or the second target RS resource group.

In one embodiment, the second transmitter 1301 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises the antenna 420, the transmitter 418, the multi-antenna transmitting processor 471 and the transmitting processor 416 in FIG. 4 of the present application.

In one embodiment, the second transmitter 1301 comprises the antenna 420, the transmitter 418 and the transmitting processor 416 in FIG. 4 of the present application.

In one embodiment, the second receiver 1302 comprises the antenna 420, the receiver 418, the multi-antenna receiving processor 472, the receiving processor 470, the controller/processor 475 and the memory 476 in FIG. 4 of the present application.

In one embodiment, the second receiver 1302 comprises the antenna 420, the receiver 418, the multi-antenna receiving processor 472 and the receiving processor 470 in FIG. 4 of the present application.

In one embodiment, the second receiver 1302 comprises the antenna 420, the receiver 418 and the receiving processor 470 in FIG. 4 of the present application.

### Embodiment 14

Embodiment 14 illustrates a schematic diagram of a target observation set consisting of at least one of a first target RS resource group or a second target RS resource group according to one embodiment of the present application, as shown in FIG. 14.

In Embodiment 14, an RS resource for radio link monitoring is related to all RS resources in a target observation set, and the RS resource for radio link monitoring is unrelated to any RS resource other than the target observation set; the target observation set consists of at least one of the first target RS resource group or the second target RS resource group.

In one embodiment, the first node performs radio link monitoring according to all RS resources in the target observation set.

In one embodiment, the sentence that “an RS resource for radio link monitoring is related to all RS resources in a target observation set, and the RS resource for radio link monitoring is unrelated to any RS resource other than the target observation set” comprises that: whether the physical layer of the first node transmits a first-type indication to a higher layer of the first node is related to all RS resources in the target observation set and unrelated to an RS resource other than the target observation set.

In one embodiment, the sentence that “an RS resource for radio link monitoring is related to all RS resources in a target observation set, and the RS resource for radio link monitoring is unrelated to any RS resource other than the target observation set” comprises that: only an RS in the target observation set is used for radio link monitoring, and an RS other than the target observation set is not used for radio link monitoring.

In one embodiment, when radio link quality of each RS resource in a target observation set is worse than Q_{out,LR}, the physical layer of the first node provides a first-type indication to a higher layer of the first node.

In one embodiment, when radio link quality of each RS resource in a target observation set is worse than Qₒᵤₜ, the physical layer of the first node provides a first-type indication to a higher layer of the first node.

In one embodiment, when there is one RS resource in a target observation set of which radio link quality is better than Qᵢₙ, the physical layer of the first node provides a first-type indication to a higher layer of the first node.

In one embodiment, the target observation set comprises the first RS resource group.

In one embodiment, the target observation set comprises a subset of the first RS resource group.

In one embodiment, the target observation set comprises the second RS resource group.

In one embodiment, the target observation set comprises a subset of the second RS resource group.

In one embodiment, the target observation set comprises at least one RS in the first RS resource group, and the target observation set comprises at least one RS in the second RS resource group.

In one embodiment, the target observation set comprises the first target RS resource group.

In one embodiment, the target observation set comprises the second target RS resource group.

In one embodiment, the target observation set comprises the first target RS resource group and the second target RS resource group.

In one embodiment, the radio link monitoring includes: performing radio link monitoring according to a target observation set.

In one embodiment, before a first time, the target observation set is the second target RS resource group; after the first time, the target observation set is the first target RS resource group.

In one embodiment, before a first time, the target observation set is the first target RS resource group; after the first time, the target observation set is the first target RS resource group and the second target RS resource group.

In one embodiment, before a first time, the target observation set is the second target RS resource group; after the first time, the target observation set is the first target RS resource group and the second target RS resource group.

In one embodiment, a number of candidate connection(s) between the first node and the first cell and the second cell is used to determine the target observation set.

In one subembodiment, the candidate connection includes a physical channel, the physical channel including at least one of a PDCCH or a PDSCH or a PUSCH.

In one subembodiment, the candidate connection includes neither a PBCH nor a BCCH.

In one subembodiment, when the first node can only receive a PDCCH from one of the first cell or the second cell, the number of the candidate connection(s) is equal to 1; when the first node can receive a PDCCH from both the first cell and the second cell, the number of the candidate connection(s) is equal to 2.

In one subembodiment, when the number of the candidate connection(s) is equal to 1, the target observation set consists of the first target RS resource group or the second target RS resource group.

In one subembodiment, when the number of the candidate connection(s) is equal to 2, the target observation set consists of the first target RS resource group and the second target RS resource group.

In one subembodiment, the cell identified by the first PCI is a first cell.

In one subsidiary embodiment of the above subembodiment, just before the action of performing a first action set, the target observation set consists of the first target RS resource group and the second target RS resource group; right after the action of performing a first action set, the target observation set consists of the first target RS resource group.

In one subsidiary embodiment of the above subembodiment, just before the action of performing a first action set, the target observation set consists of the second target RS resource group; right after the action of performing a first action set, the target observation set consists of the first target RS resource group.

In one subembodiment, the cell identified by the first PCI is a second cell.

In one subsidiary embodiment of the above subembodiment, just before the action of performing a first action set, the target observation set consists of the second target RS resource group; right after the action of performing a first action set, the target observation set consists of the first target RS resource group.

In one subsidiary embodiment of the above subembodiment, just before the action of performing a first action set, the target observation set consists of the second target RS resource group; right after the action of performing a first action set, the target observation set consists of the first target RS resource group and the second target RS resource group.

In one embodiment, the phrase just before an action indicates that a time interval exists before the action.

In one embodiment, the phrase just before an action indicates being in at least a period of time before the action.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, characterized in comprising:
a first receiver, which receives a first signaling, the first signaling used for configuring a first Reference Signal (RS) resource group, with all RS resources in the first RS resource group being associated with a first Physical Cell Identity (PCI); and which receives a second signaling, the second signaling used for determining a first target RS resource group, any RS resource in the first target RS resource group belonging to the first RS resource group; and which performs a first action set as a response to the action of receiving the second signaling, the first action set including resetting a count of first-type indication(s);
wherein the first RS resource group comprises at least one RS resource; the first signaling is a Radio Resource Control (RRC) layer signaling; the second signaling is a signaling at protocol layer below the RRC layer, the second signaling comprising a MAC Control Element (CE); the first target RS resource group is used for radio link monitoring; the first-type indication is related to a link failure; the first action set includes: performing radio link monitoring only according to the first target RS resource group in the first RS resource group.

2. The first node according to claim 1, characterized in comprising:
the first receiver, which receives a third signaling, the third signaling used for configuring a second RS resource group, with all RS resources in the second RS resource group being associated with a second PCI;
wherein the first action set includes: performing radio link monitoring only according to a second target RS resource group in the second RS resource group; any RS resource in the second target RS resource group belongs to the second RS resource group; the second target RS resource group is used for radio link monitoring; the first PCI is different from the second PCI.

3. The first node according to claim 2, characterized in that the third signaling and the first signaling belong to a same RRC message; the phrase of the third signaling used for configuring a second RS resource group includes: the third signaling being used to determine an index and a type of each RS resource in the second RS resource group.

4. The first node according to claim 2, characterized in that an IE RadioLinkMonitoringConfig in the third signaling is used for indicating the first RS resource group; a detectionResource field in the third signaling is used for configuring a type and an index of one RS resource in the second RS resource group.

5. The first node according to claim 2, characterized in that the phrase of all RS resources in the second RS resource group being associated with a second PCI includes: all RS resources in the second RS resource group belonging to a cell identified by the second PCI.

6. The first node according to claim 2, characterized in that the first RS resource group belongs to a cell identified by the first PCI, while the second RS resource group belongs to a cell identified by the second PCI; the first PCI is a PCI of a first cell, while the second PCI is a PCI of a second cell; the first cell is a serving cell of the first node, the serving cell referring to a Primary Cell (PCell)or a Primary Secondary Cell (PSCell) or a Secondary Cell (SCell).

7. The first node according to claim 2, characterized in that any RS resource in the first RS resource group is different from any RS resource in the second RS resource group.

8. The first node according to claim 1, characterized in comprising:
the first receiver, each time when a radio link quality evaluated is worse than a first threshold, a physical layer of the first node reports a first indication to a higher layer of the first node; the first-type indication includes the first indication.

9. The first node according to claim 1, characterized in comprising:
the first receiver, which receives the first-type indication at a higher layer of the first node after a first-type indication is reported to the higher layer of the first node from a physical layer of the first node; and which increments the count of first-type indication(s) by 1 as a response to the action of receiving the first-type indication at the higher layer of the first node;
wherein the first value is equal to beamFailureInstanceMaxCount.

10. The first node according to claim 1, characterized in that an RS resource for radio link monitoring is related to all RS resources in a target observation set, and the RS resource for radio link monitoring is unrelated to any RS resource other than the target observation set; the target observation set consists of at least one of the first target RS resource group or the second target RS resource group.

11. The first node according to claim 1, characterized in that the phrase of the second signaling used for determining a first target RS resource group includes: the second signaling being used to determine an activation of the first target RS resource group.

12. The first node according to claim 1, characterized in that the phrase of the second signaling used for determining a first target RS resource group includes: the second signaling explicitly indicating an RS resource identifier in the first target RS resource group.

13. The first node according to claim 1, characterized in that the first signaling comprises a RRCReconfiguration message; an IE RadioLinkMonitoringConfig in the first signaling is used for indicating the first RS resource group.

14. The first node according to claim 1, characterized in that a BFI_COUNTER is used for counting the first-type indication(s); the first-type indication is a beam failure instance indication; the link failure includes: a beam link failure; the radio link monitoring includes: a link recovery procedure.

15. The first node according to claim 1, characterized in that the sentence of “performing radio link monitoring only according to the first target RS resource group in the first RS resource group” includes: all RS resources in the first target RS resource group in the first RS resource group being used for radio link monitoring, and any RS resource other than the first target RS resource group in the first RS resource group not being used for performing radio link monitoring.

16. The first node according to claim 1, characterized in that a type of an RS resource includes SSB resource or CSI-RS resource.

17. The first node according to claim 1, characterized in that the first target RS resource group comprises only one RS resource; or, the first target RS resource group comprises at least one RS resource.

18. The first node according to claim 1, characterized in that the phrase of all RS resources in the first RS resource group being associated with a first PCI includes: all RS resources in the first RS resource group belonging to a cell identified by the first PCI.

19. A second node for wireless communications, characterized in comprising:
a second transmitter, which transmits a first signaling, the first signaling used for configuring a first RS resource group, with all RS resources in the first RS resource group being associated with a first PCI; and which transmits a second signaling, the second signaling used for determining a first target RS resource group, any RS resource in the first target RS resource group belonging to the first RS resource group;
wherein as a response to the second signaling being received, a first action set is performed, the first action set including resetting a count of first-type indication(s); the first RS resource group comprises at least one RS resource; the first signaling is an RRC layer signaling; the second signaling is a signaling at protocol layer below the RRC layer, the second signaling comprising a MAC CE; the first target RS resource group is used for radio link monitoring; the first-type indication is related to a link failure; the first action set includes: performing radio link monitoring only according to the first target RS resource group in the first RS resource group.

20. A method in a first node for wireless communications, characterized in comprising:
receiving a first signaling, the first signaling used for configuring a first RS resource group, with all RS resources in the first RS resource group being associated with a first PCI; and receiving a second signaling, the second signaling used for determining a first target RS resource group, any RS resource in the first target RS resource group belonging to the first RS resource group; and performing a first action set as a response to the action of receiving the second signaling, the first action set including resetting a count of first-type indication(s);
wherein the first RS resource group comprises at least one RS resource; the first signaling is an RRC layer signaling; the second signaling is a signaling at protocol layer below the RRC layer, the second signaling comprising a MAC CE; the first target RS resource group is used for radio link monitoring; the first-type indication is related to a link failure; the first action set includes: performing radio link monitoring only according to the first target RS resource group in the first RS resource group.
